(19) United States
(12) Patent Application Publication
(10) Pub. No.: US 2018/0293619 A1
(43) Pub. Date: Oct. 11, 2018

(54) NODE BASED CUSTOMER SEGMENTATION IN PARKING GARAGES

(71) Applicant: Parketing Intelligence LLC, Cincinnati, OH (US)

(72) Inventors: Matthew Tobias Asbury, Cincinnati, OH (US); Robert William Tracy, Cincinnati, OH (US); Rahul Bawa, Cincinnati, OH (US)

(21) Appl. No.: 15/946,547

(22) Filed: Apr. 5, 2018

Related U.S. Application Data
(63) Continuation-in-part of application No. 15/479,620, filed on Apr. 5, 2017.

(51) Int. Cl. G06Q 30/02

(52) U.S. Cl. CPC G06Q 30/0261; G06Q 30/0224; G07F 17/42; G06Q 30/0226; G06Q 30/0211

(57) ABSTRACT

A system for segmenting computing devices entering a parking facility. The system can include at least three nodes, the three nodes having locations known via GPS technology and capable of receiving at least one device fingerprint from a broadcast signal from at least one computing device in a target area. The three nodes can be calibrated to determine the geolocation of the at least one computing device through trilateration. A credential dispensing station can be situated such that upon entry to the parking facility, a user in possession of one of the at least one computing device is in the target area when receiving a dispensed credential. A processor and memory can have executable instructions for associating the at least one device fingerprint with information relating to the dispensed credential.

### REFERENCE TO RELATED APPLICATION

The present application is a continuation-in-part (CIP) of U.S. patent application Ser. No. 15/479,620, filed Apr. 5, 2017, which is hereby incorporated by reference in its entirety.

### TECHNICAL FIELD

Embodiments of the technology relate, in general, to systems and methods for segmenting customers based on observed behavior and providing parking validation and rewards in general, and specifically in relation to parking facilities.

Portions of this patent application contain materials that are subject to copyright protection. The copyright owner has no objection to the facsimile reproduction by anyone of the patent document or the patent disclosure, as it appears in the Patent and Trademark Office patent file or records. The copyright owner, however, otherwise reserves all copyright rights whatsoever.

### BACKGROUND OF THE INVENTION

The present invention relates to computer-aided marketing system, and more particularly to a targeted marketing system, specially suitable for use with parking facilities, that provides a collaborative process in which clients, such as businesses and/or individuals can create targeted advertisements and incentives for presenting to the public (“customers”) or to specific customers using various outlets, such as competing and non-competing clients. In an embodiment the system allows clients to select a geographical and/or a demographical audience that have been segmented based on the “type” of customer as well as allowing clients to monitor the advertisements or incentives for optimizing marketing efforts.

Use of targeted advertising has increased significantly in recent years with the advent of various telecommunication means, including Wi-Fi and the Internet. The Internet has connected people, businesses, and organizations through various means that include online bulletin boards, Email, and online instant messaging. Businesses often prefer to control advertising and marketing costs by targeting customers and potential customers using such cost effective means.

Clients, such as parking facilities including pay to use parking lots, single level and multiple parking garages, are often utilized by customers for parking during work, attending an event, for going to a restaurant or for shopping. Automated timing and payment systems have been utilized at the entrance to a parking facility to receive payment from a customer wishing to park at the facility or to issue a ticket to a customer that operates to record the time that the customer entered the facility and is used at an exit to the facility for calculating the amount owed by the customer. Other systems have been developed for communicating with customers who are seeking a parking facility and operate to provide a potential customer with information regarding the availability of parking spaces within the parking facility. One difficulty with parking facilities is that they often operate using monitoring and payment systems that are not compatible for interacting or exchanging information with other monitoring and payment systems used by other parking facilities. Accordingly, it is difficult to identify or monitor specific customers or potential customers that enter various parking facilities but who have not been entered into the specific facilities database. Further, it makes it difficult for non-related clients to cooperate to create incentives that target potential mutual customers.

In order to increase customer traffic to various businesses, such as retail and service establishments, systems have also been developed for obtaining parking information by identifying a vehicle that enters a specific parking location and provides a parking discount for users that have made a financial transaction with a business within a defined area around the parking facility. Such systems often operate using optical devices that identify the vehicle using the vehicle's license plate and uses information previously inputted into the identification system by the vehicle user. Unfortunately, for accuracy such systems require customers to enter into a data base a listing of all vehicles that may be driven by a customer. Further, such systems would not operate to identify a customer if the customer was driving a rented vehicle or a vehicle that is not listed as being one driven by the customer. Another problem associated with such systems is that for operation a customer must have previously entered information into the system being used by the parking facility. This is often undesirable to a customer that only plans to use the facility once or periodically. Further, as stated, customer identification in parking facilities is difficult and requires customers to interact with individual disparate and proprietary physical parking operation systems (POS). Usually these systems are numbered as the amount of facilities that the customer wishes to park in. Accordingly, parking loyalty and incentive programs have been difficult and slow to develop as it is challenging to have a single credential that is accepted at all parking locations.

In addition to physical POS systems, there has been a proliferation of phone applications that customers use for reserving and finding parking spaces. Many of these applications require the customer to download an application prior to visiting the parking facility for the first time. Reserving a parking space or interacting with an application prior to arriving at a parking facility is a relatively new development and continues to represent a relatively small component of the overall revenue generated at a parking facility. Accordingly, most people still decide on the parking location impulsively by going near the area that the customer desires to go to and “looks around” for a parking location in that area.

Many targeted marking systems currently available operate to target customers that already are customers of the client. For example customers that have already registered with a client. While the collection of customer information and identification of a customer at a parking facility can be done through phone applications, there are many different types of reservation and payment applications and there is no single application that works for all related and non-related parking facilities. In addition, many systems, such as targeted marketing systems, are unable to determine how many potential customers exist for a client. Facilities, such as parking facilities, often utilize different technologies and devices for monitoring customers entering and leaving the parking facility thus making a single targeted marketing system that can be utilized by more than one client difficult. Current targeted marketing systems also do not operate to distinguish between types of customers (such as contract customers, periodic customers, event customers, and the like) making it more difficult or impossible to analyze potential customers and arrive at the most efficient and effective incentive system for identifying and targeting a customer or potential customer to promote a client (such as providing an incentive to potential customers for using the facilities of the client) or a related business client.

With regard to parking facilities, in most instances parking facilities in urban environments are owned or operated by entities other than business establishments such as retail and restaurant establishments that wish to offer incentives to their customers such as free parking. Such parking validation is used as a means to reduce or remove the “friction” that parking represents to current and potential customers. In this way, such incentive programs (parking validation) are different than most other incentive programs because the business establishments are offering to pay for the services of another entity as an incentive for becoming a customer of theirs. One problem with parking validation in urban areas is that urban businesses are often competing with the draw of suburban ease and low to no cost of parking. In addition, many times customers in urban areas only become aware that a particular business offers validation for parking only after they have visited a particular business that offers parking validation. While such urban businesses may advertise parking validation, such advertising may be relatively expensive or only is seen by known customers. Another problem with parking facilities is that customers and potential customers typically park in a multitude of garages surrounding a business. Each of these parking facilities often use disparate technologies and methodologies to monitor the coming and going of their customers and collect payment. Additionally, the trend in the industry has been toward automated systems and away from staffed facilities.

To validate parking it requires the entity validating to have a pre-defined relationship established with the parking facility. It also requires the entity validating the parking to have means to validate parking at that particular parking facility. Because the technologies are often different at each parking facility, this requires the entity validating parking to have multiple interfaces (software and/or hardware) to accomplish the validation of the customer's parking at the various parking facilities. Accordingly, the number of parking facilities an entity can actually validate is often limited and the offers at each facility remains static due to the difficulty in changing the validation amounts duration and times. Accordingly, because of the various difficulties in parking validation, the use of parking validation as an effective means of incenting behavior and is not tied to any particular promotion and loses much of its effectiveness as an incentive.

With the advent of autonomous vehicles, it is anticipated that the operations of parking facilities will change. Today, customers often pick a parking facility based on the facility's proximity to the customer's desired eventual location. For example, a customer going to a particular location (building) will typically pick a parking facility within walking distance to that particular location. With the use of autonomous vehicles, customers may be dropped off at a location and the vehicle may then travel to another location, such a parking facility, based on certain criteria, such as parking costs. This will have a fundamental effect on parking incentives, making the number of parking facilities that potential customers can park in even greater. If parking validation is to remain a viable option for incenting behavior or removing friction for urban businesses, the options of incentive need to follow the customer and not the vehicle. Additionally, the incentive once earned by the customer will need to be applied to the open parking session prior to the transaction being finalized. This will require a separate global validation system where incentives or offers of validation can be advertised and then earned and applied.

Accordingly, it would be desirable to have a targeted marketing system that can be used at a various client locations, such as parking facilities; that permits customer use at facilities having different technologies for monitoring customers entry and departing at a location; that permits unrelated clients to cooperate together to attract customers and potential customers; that permits clients to track the effectiveness of the targeted marketing; that can identify customers and potential customers; that can segment customers into one or more types and provide targeted marketing incentives to a customer based on the type of customer and other information, and can provide an analysis as to the effectiveness of the targeted marketing and incentives.

### SUMMARY OF THE INVENTION

A system for segmenting computing devices entering a parking facility. The system can include at least three nodes, the three nodes having locations known via GPS technology and capable of receiving at least one device fingerprint from a broadcast signal from at least one computing device in a target area. The three nodes can be calibrated to determine the geolocation of the at least one computing device through trilateration. A credential dispensing station can be situated such that upon entry to the parking facility, a user in possession of one of the at least one computing device is in the target area when receiving a dispensed credential. A processor and memory can have executable instructions for associating the at least one device fingerprint with information relating to the dispensed credential.

### BRIEF DESCRIPTION OF THE INVENTION

Features, aspects, and advantages of the present invention will become better understood with regard to the following description, appended claims, and accompanying drawings where:

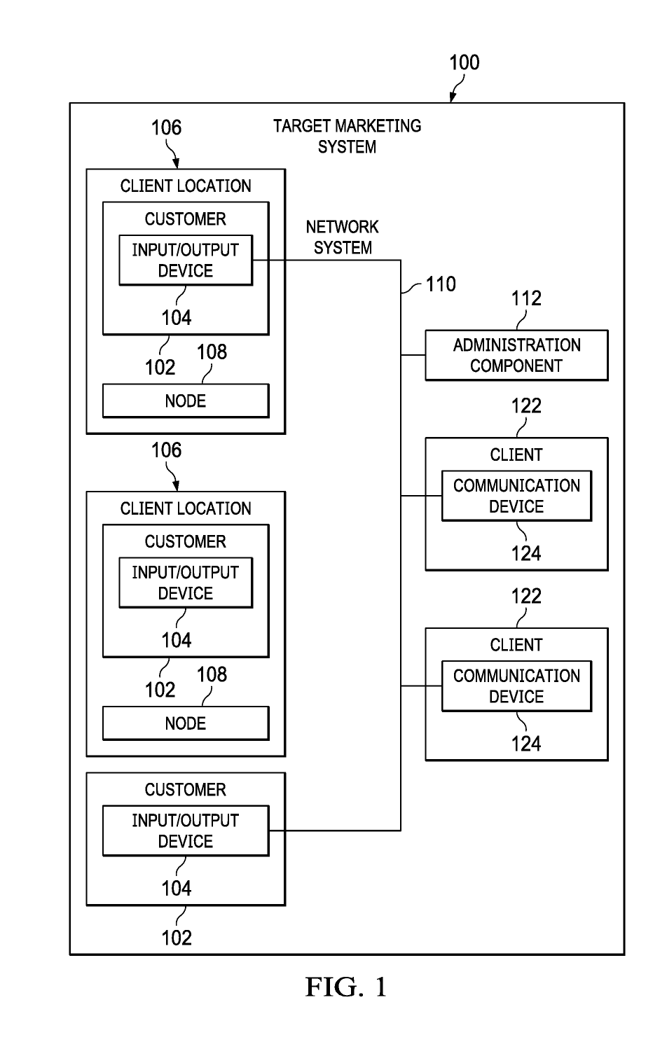

FIG. 1 is a schematic representation of an embodiment of the targeted advertising system of the subject invention showing one or more customers each at a customer location having a least one node in communication with each client communication devices using a wireless local area networking system, an emitted signal administrative component for receiving information from each customer input/output device;

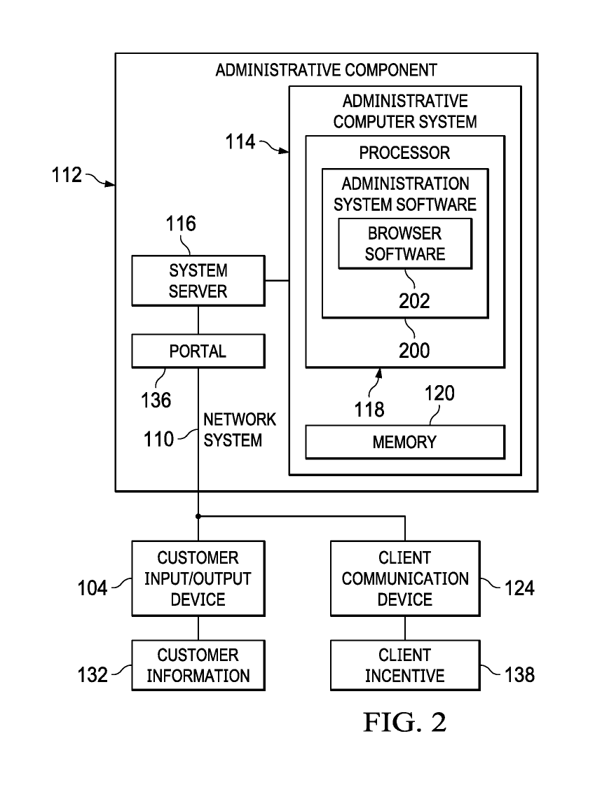

FIG. 2 is a schematic representation showing an administrative component having an administrative computer system having a processor for operating administrative system software and in communication with customer input/output devices and client communication devices through a system server;

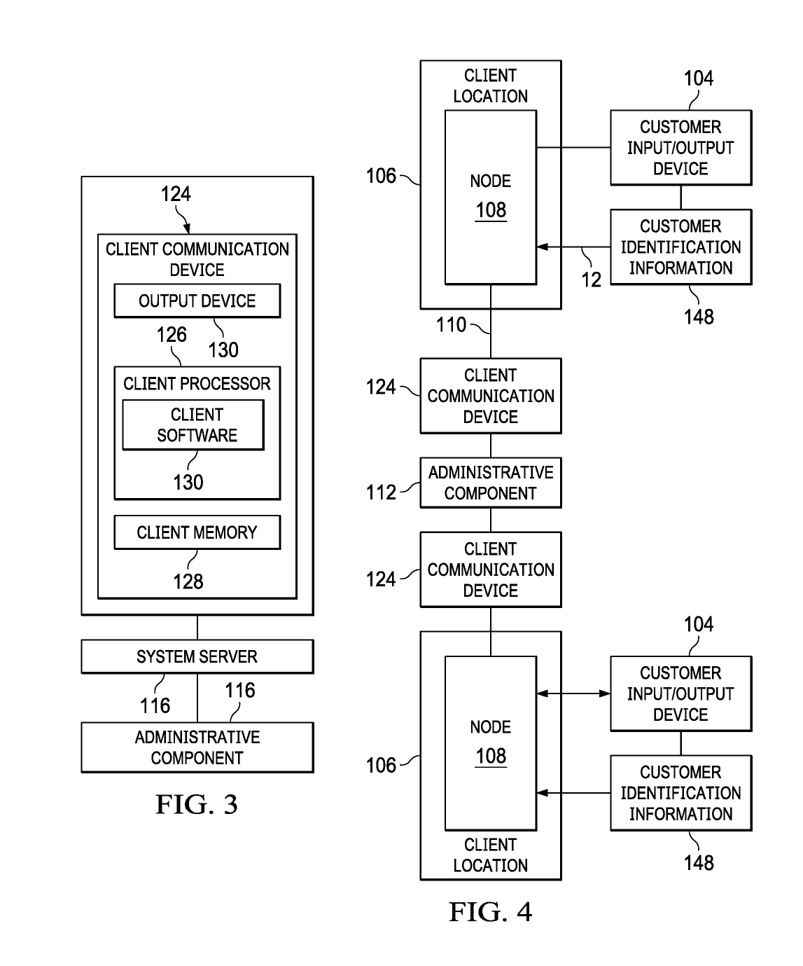

FIG. 3 is a schematic representation showing a client having a client communication device connected to the administrative component through a system server;

FIG. 4 is a schematic representation showing client locations each having a node for receiving customer identification information through a customer input/output device;

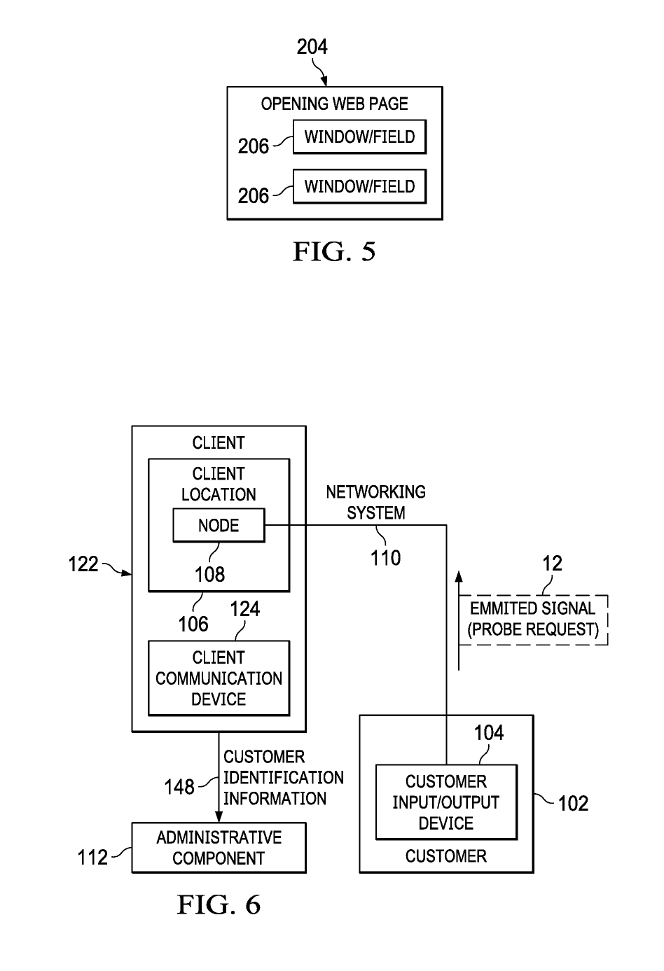

FIG. 5 is a schematic representation showing an opening web page having one or more windows or fields for entering customer information;

FIG. 6 is a schematic representation showing a customer entering a client location and the customer input/output device sends a probe request that is received by the node at the client location and transmits customer identification information to the administrative component;

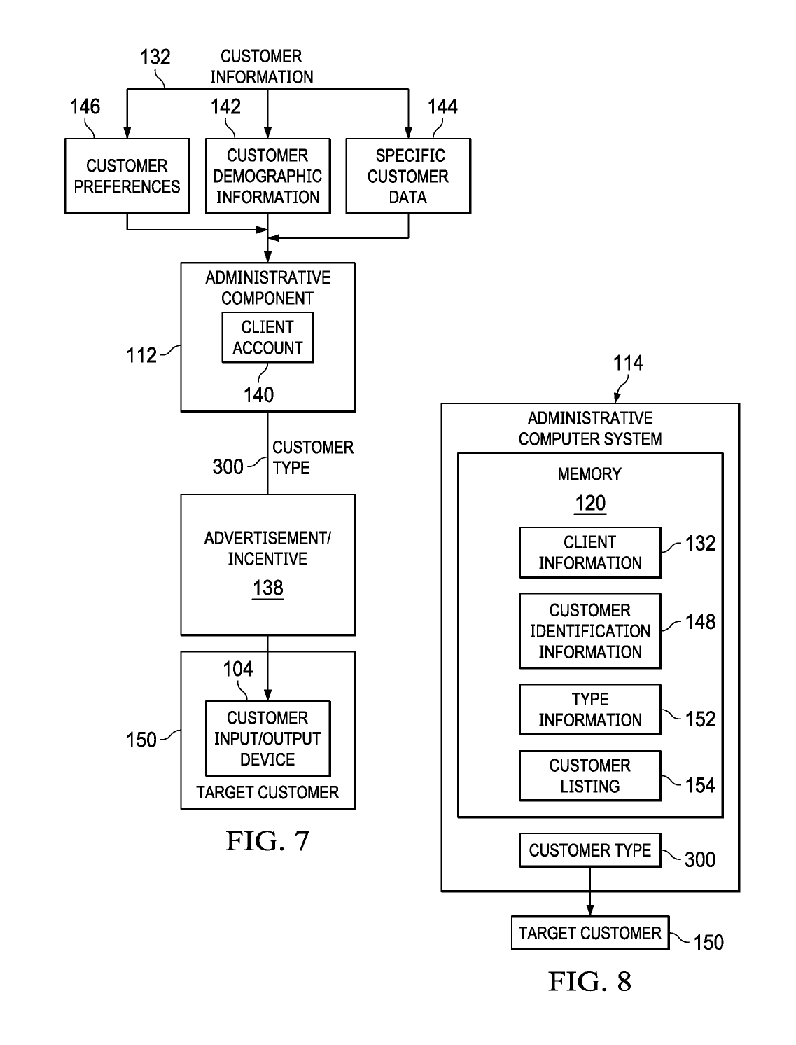

FIG. 7 is a schematic representation showing an embodiment of the operation of the targeted marketing system of the subject invention whereby customer preferences, customer demographics and customer information is used by the administrative component to determine a customer type and sends an advertisement/incentive to a target customer;

FIG. 8 is a schematic representation showing an embodiment of the targeted marketing system of the subject invention showing the use of client information, customer identification information, customer listing and type information to determine a customer type for a targeted customer;

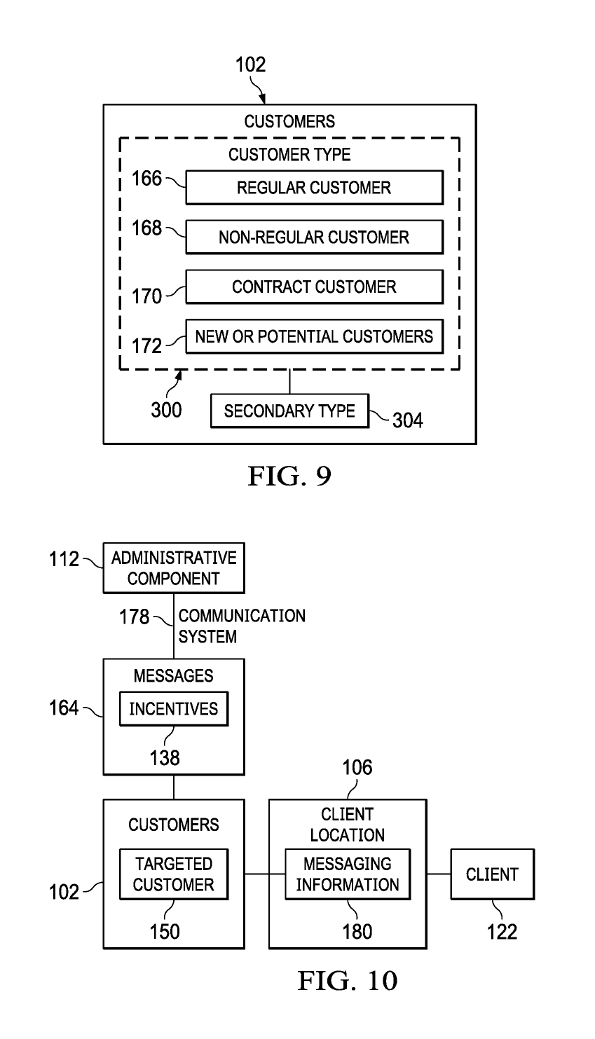

FIG. 9 is a schematic representation showing the customers and being regular customers, non-regular customers, contract customers, and new or potential customers;

FIG. 10 is a schematic representation showing the administrative component operating to send messages or incentives to customers, such as a targeted customer, or for a customer to receive or obtain messaging information at a client location;

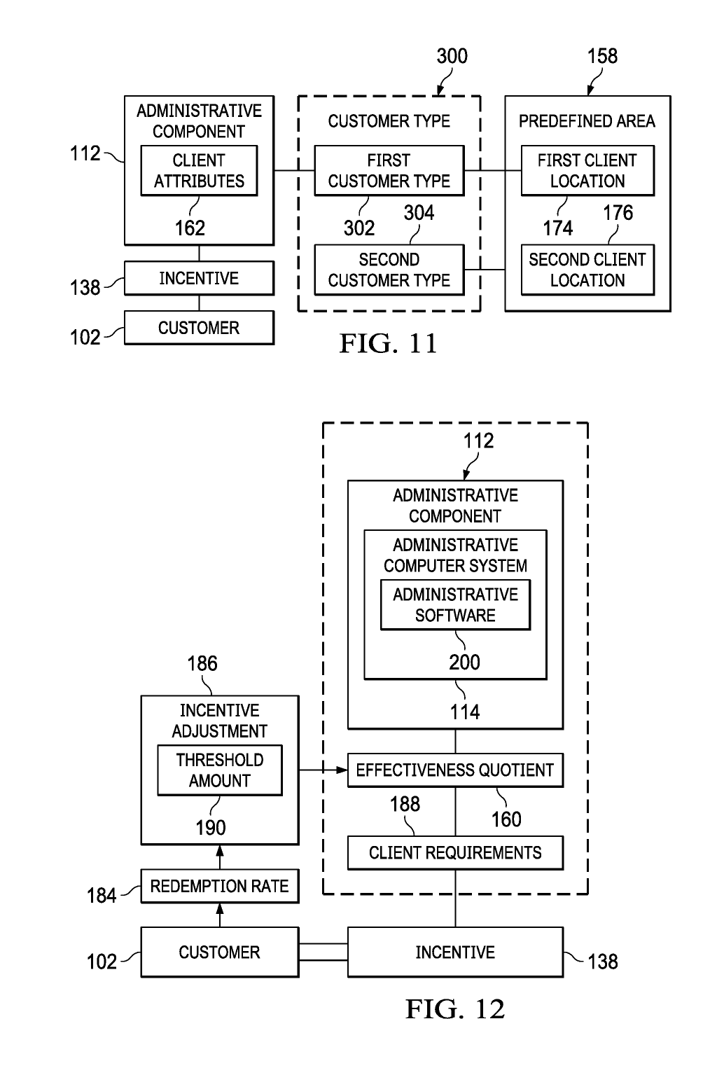

FIG. 11 is a schematic representation showing a first type of client having a first client location and one or more second clients each having a second client location working together through the administrative component of the targeted marketing system of the subject invention to provide one or more incentives to customers or potential customers;

FIG. 12 is a schematic representation showing system software of the administrative component operating to utilize the redemption rate of an incentive to calculate an effectiveness quotient for a segmented type;

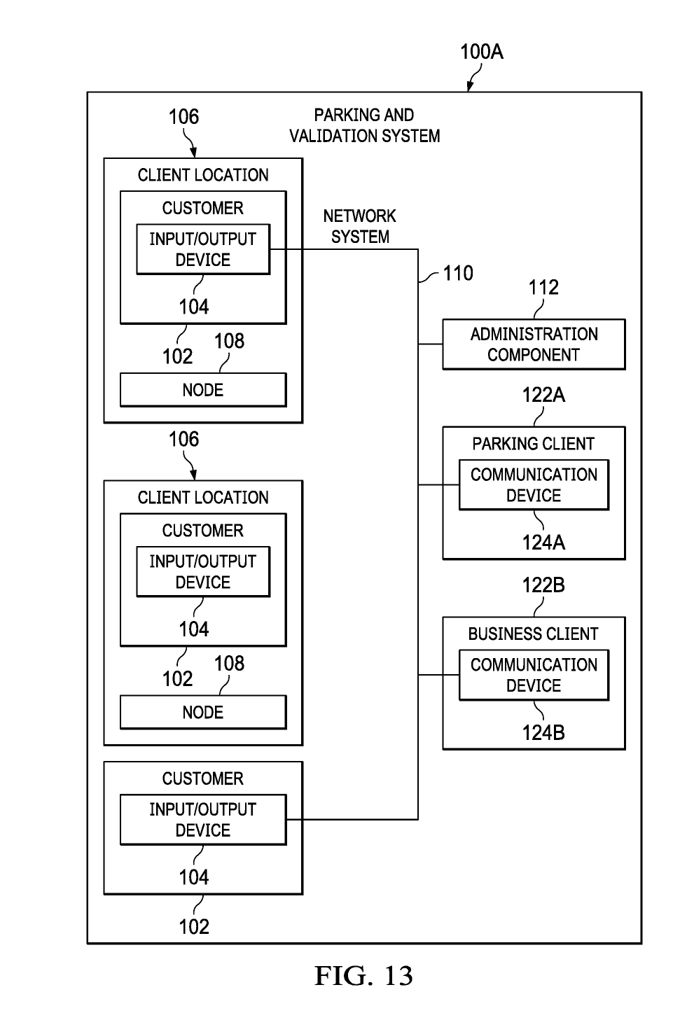

FIG. 13 is a schematic representation of an embodiment of a parking and validation system;

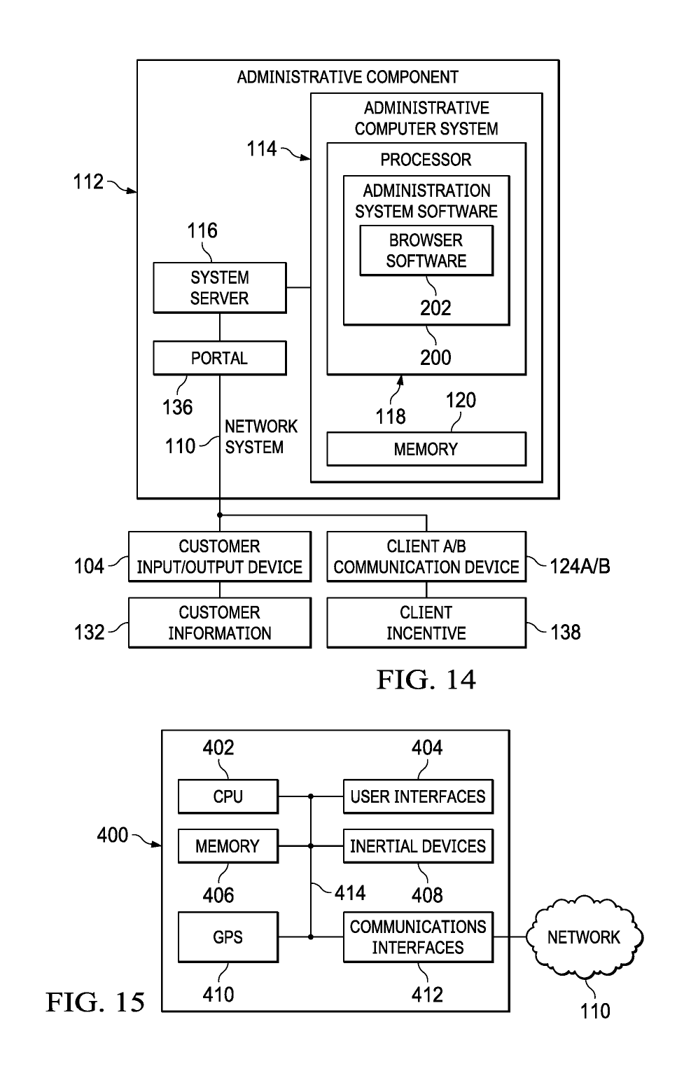

FIG. 14 is a schematic representation showing an embodiment of an administrative component of the parking and validation system;

FIG. 15 is a schematic representation of a computing device of an embodiment of parking and validation system;

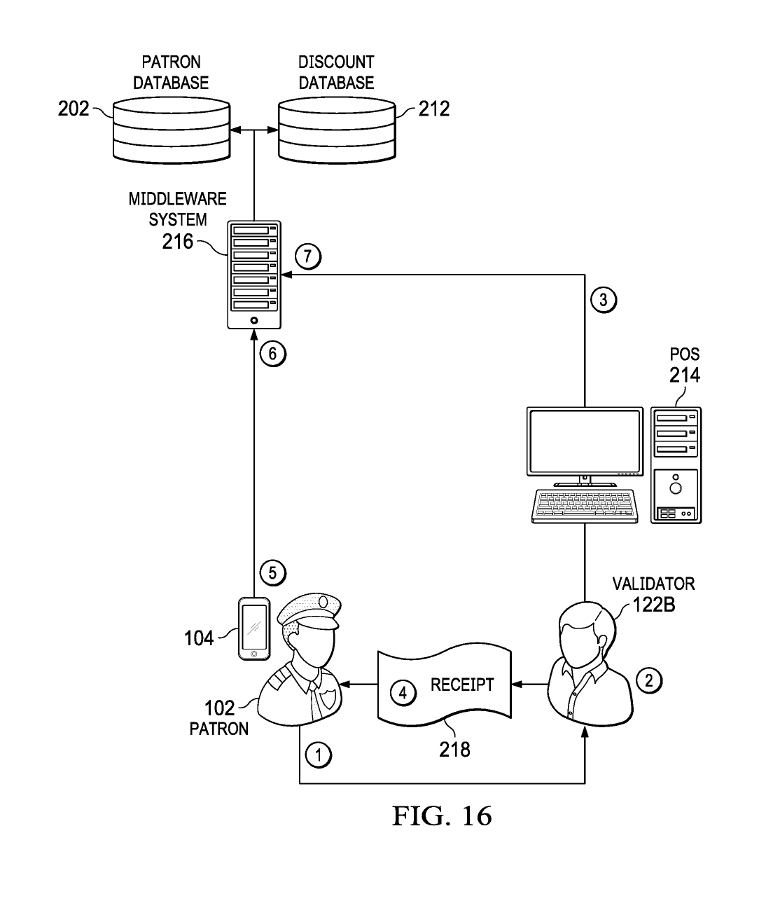

FIG. 16 is a schematic representation of an embodiment of a system and method of a parking and validation system;

FIG. 16 is a schematic representation of an embodiment of a system and method of a parking and validation system;

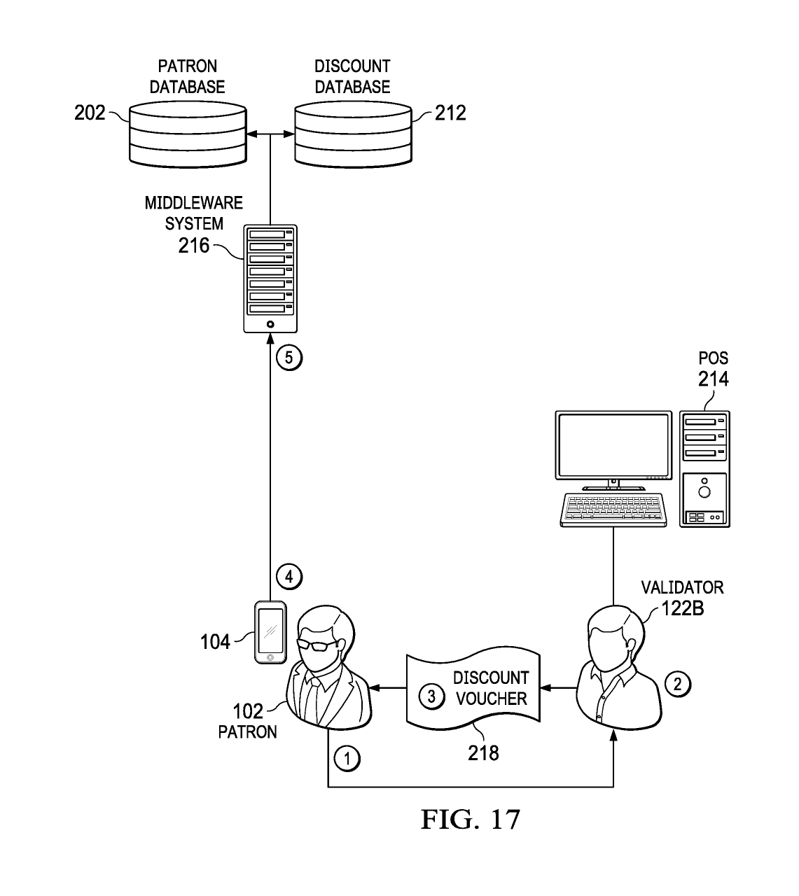

FIG. 17 is a schematic representation of an embodiment of a system and method of a parking and validation system;

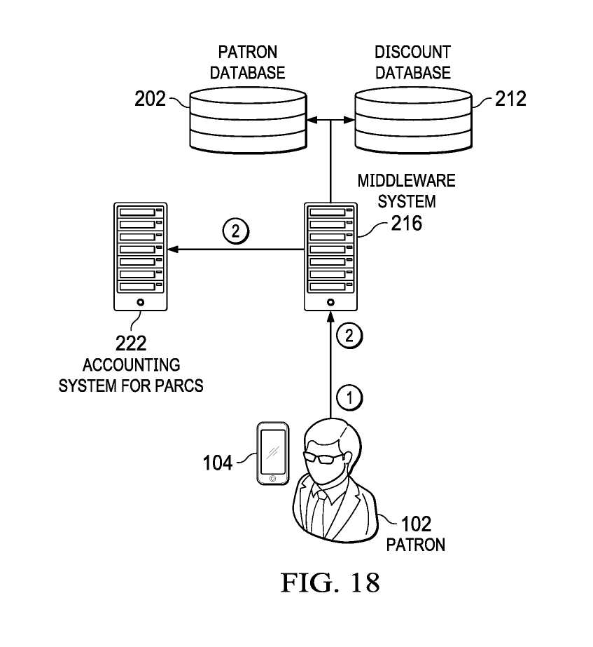

FIG. 18 is a schematic representation of an embodiment of a system and method of a parking and validation system;

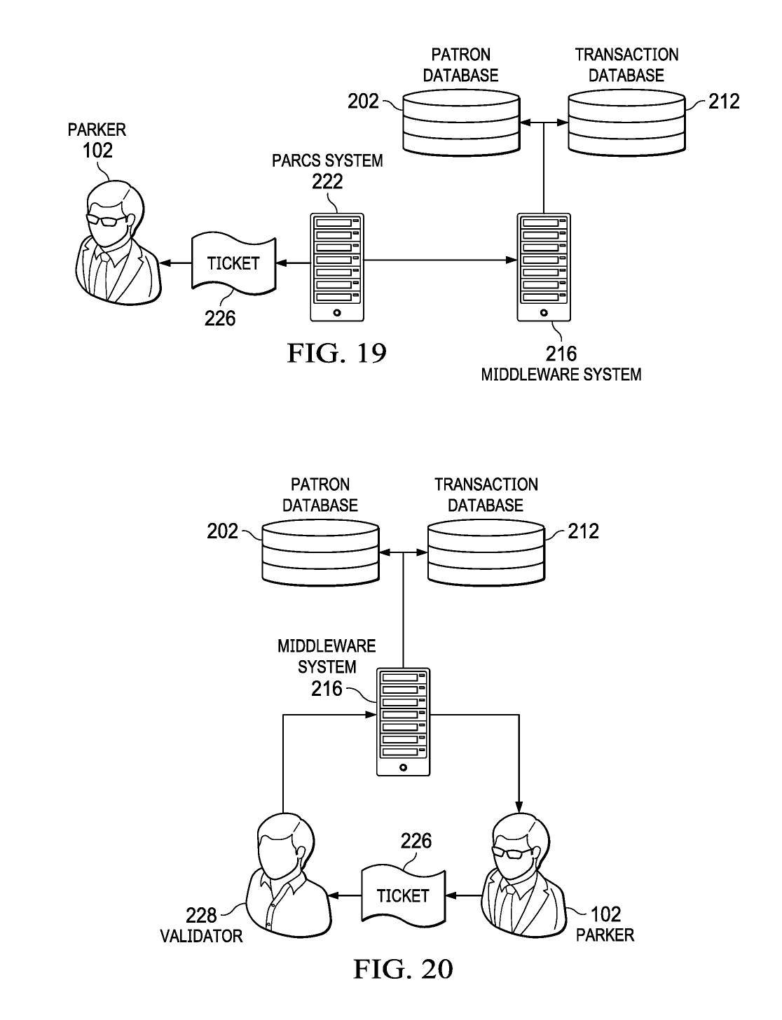

FIG. 19 is a schematic representation of an embodiment of a system and method of a parking and validation system;

FIG. 20 is a schematic representation of an embodiment of a system and method of a parking and validation system;

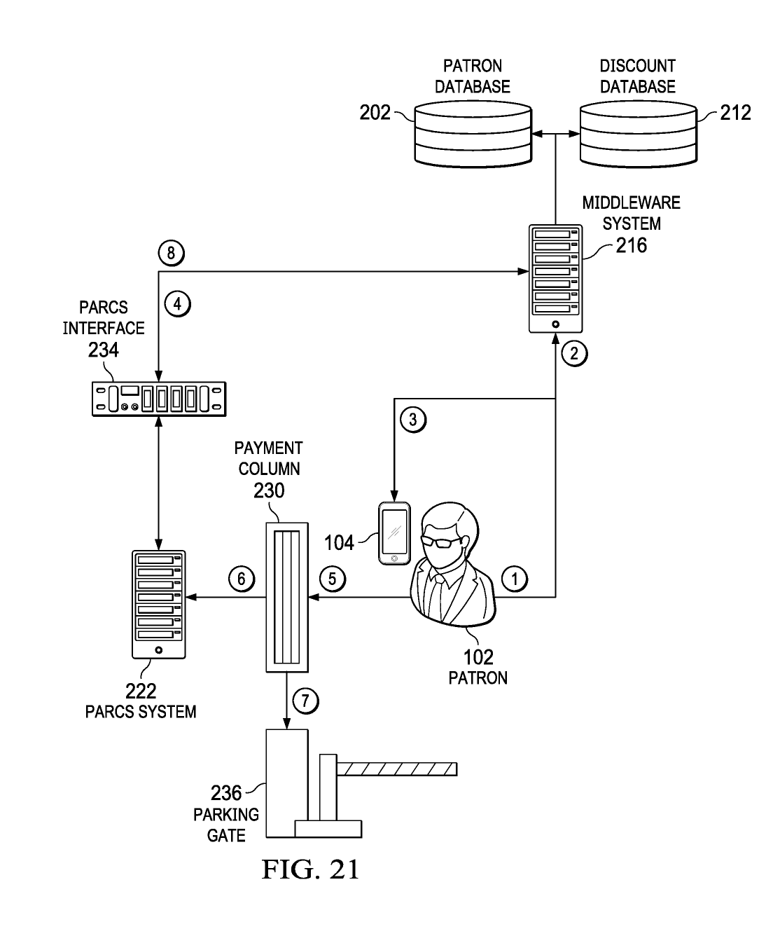

FIG. 21 is a schematic representation of an embodiment of a system and method of a parking and validation system;

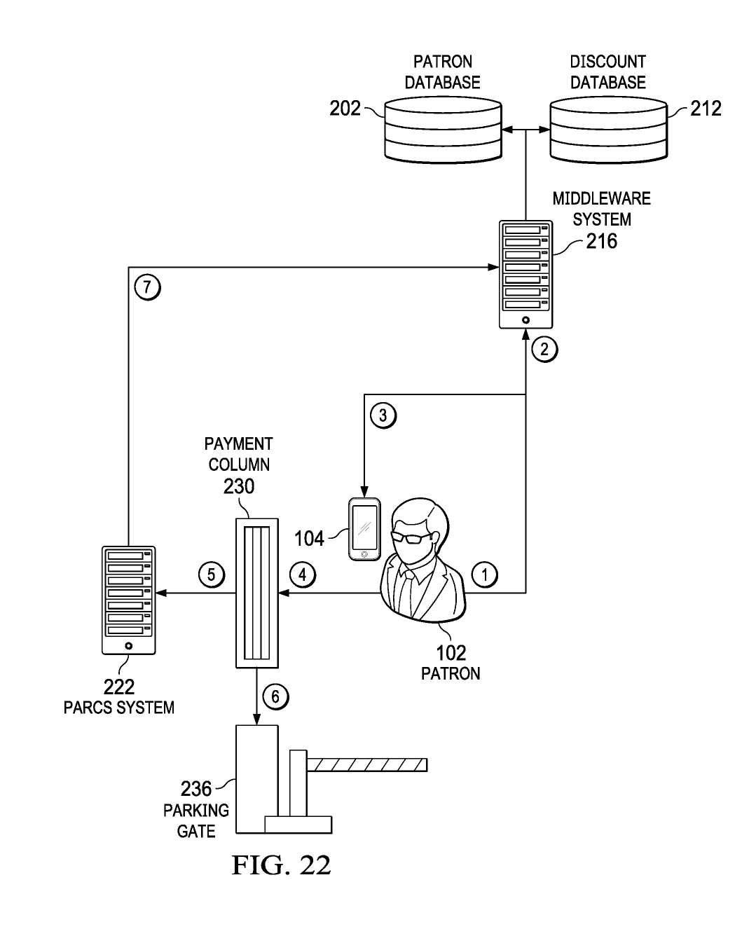

FIG. 22 is a schematic representation of locations of customers in a system and method of a parking and validation system;

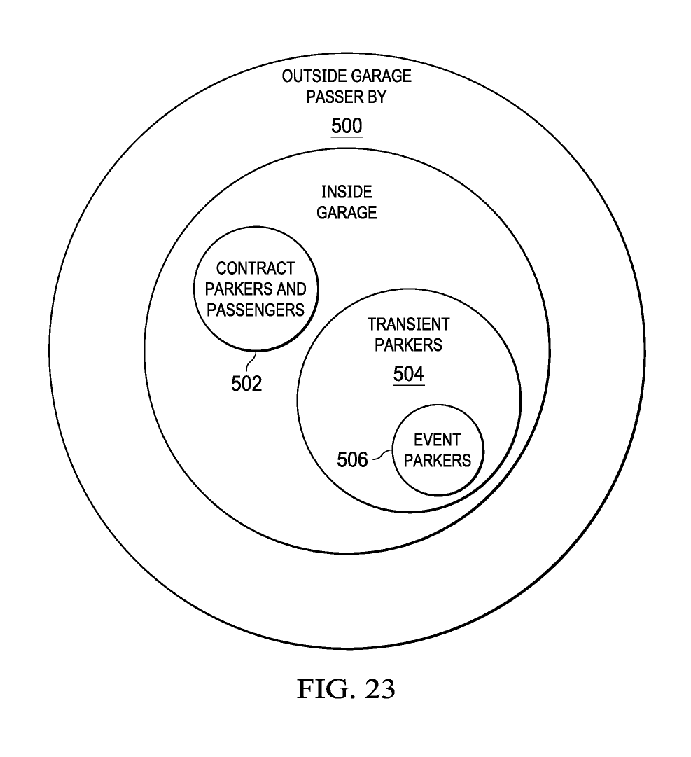

FIG. 23 is a schematic representation of an embodiment of a system and method of a determining valid signal data;

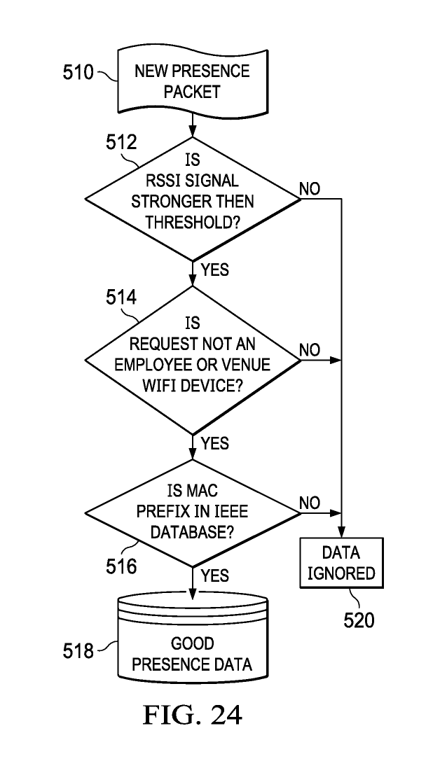

FIG. 24 is a schematic representation of a system and method for determining valid MAC addresses;

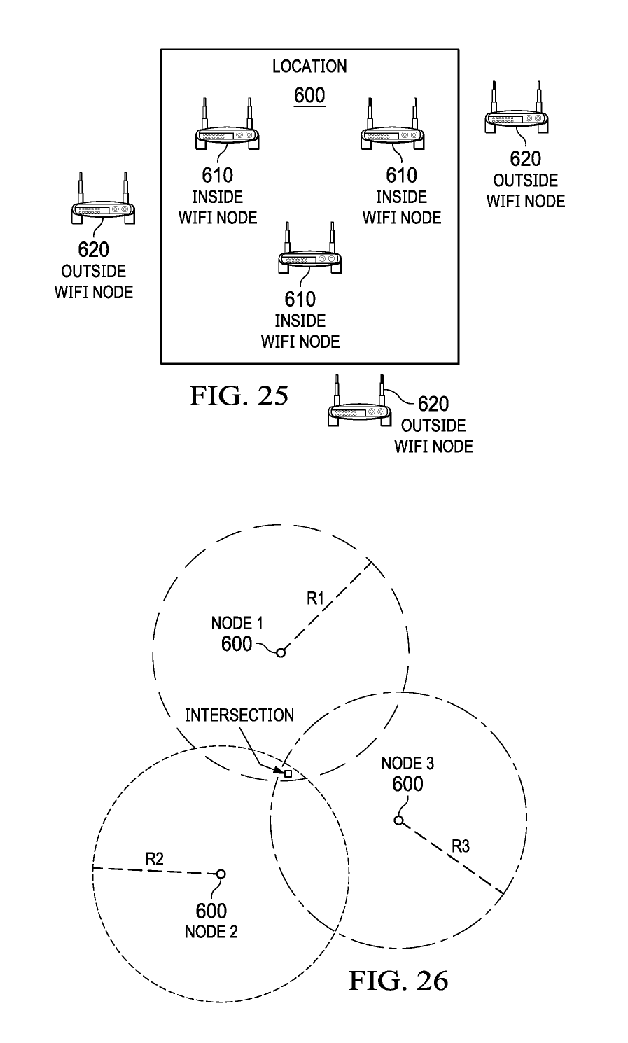

FIG. 25 is a schematic representation of nodes in a system and method of a parking and validation system;

FIG. 26 is a schematic representation of an embodiment of a system and method of trilateration for a parking and validation system; and

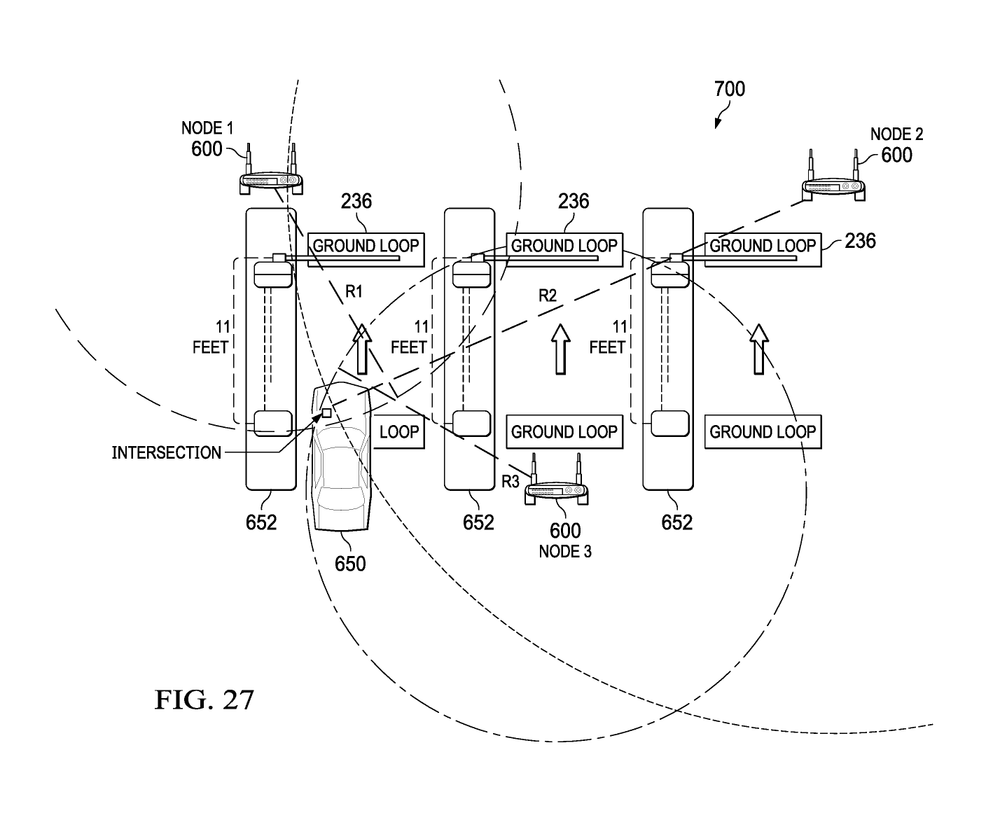

FIG. 27 is a schematic representation of an embodiment of a parking facility utilizing an embodiment of a system and method of trilateration for a parking and validation system.

### DETAILED DESCRIPTION OF THE INVENTION

Various non-limiting embodiments of the present disclosure will now be described to provide an overall understanding of the principles of the structure, function, and use of the systems and methods disclosed herein. One or more examples of these non-limiting embodiments are illustrated in the selected examples disclosed and described in detail with reference made to FIGS. 1-25 in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

The present invention solves the prior art problems discussed above and provides a distinct advance in the state of the art. The targeted marketing system of the present invention preferably is a computer-aided system that operates to provide a collaborative advertising and marketing structure whereby clients, such as businesses, create advertising and select specific marketing channels that target audiences (customers) thereby optimizing their marketing efforts. The system operates to permit on-line sale of goods and services through multiple disparate applications and by true transient currently anonymous transactions. The “single customer view” allows for segmentation and rewards that incentivize the customer while allowing surrounding clients (businesses) to market and incent behavior through the use of targeted incentives, such as the use of parking validations. As used herein the term “client” or “clients” refer to businesses that use the targeted marketing system of the subject invention. Such clients can be related clients (businesses owned or operated by the same entity) or unrelated clients (businesses owned or operated by different entities). The term “client location” or “client locations” refer to a specific location owned or operated by a client. As used herein the term “first client location” refers to the client location that the customer first enters. The term “second client location” refers to a subsequent client location that a customer approaches or enters after leaving the first client location. The term “customer” or “customers” refer to individuals that enter a client location. The term “potential customer” or “potential customers” refer to individuals that a client desires or attempting to make as a customer at the client location.

Referring to FIG. 1, a schematic illustration of the methodology of the targeted marketing system 100 of the subject invention is shown comprising a plurality of customers 102 each having an input/output device 104. As shown, a customer 102 can be located within a client location 106 or outside a client location. Each client location 106 includes one or more nodes 108 that operate to determine the presence of a customer 102 using the customer's input/output device 104. Preferably, the node 108 also operates to record a time when a customer 102 enters a client location 106 and a time when the customer 102 leaves the client location 106 and transmits the time(s) using a network system 110 to an administrative component 112. Preferably, as shown in FIG. 2, the administrative component 112 comprises an administrative computer system 114 for implementing and operating the administrative system software 200 that performs the method of the subject invention and is operated by a system administrator (not shown). The administrative computer system 114 is electrically linked to at least one server 116 used to assess and retrieve information with respect to the network system 110 as described herein below. The administrative computer system 114 includes a processor 118 for operating the administrative software system 200 and a memory 120 that can be electronically coupled to other devices, such as a suitable input device, like a keypad, touch screen, or any other suitable input device (not shown) that can accept and store information, and one or more suitable output devices (not shown), such as a computer display, printer, and the like. Memory 120 can include database modules, including a client database. It should be understood that the administrative computer system 114 can include any combination of the above components, or any number of different components, peripherals, and other device. Preferably, the administrative computer system 114 operates under the control of an operating system, such as the WINDOWS operating system developed by Microsoft Corporation or the MACINTOSH operating system developed by Apple Computer Corporation. It should be understood, however, that other operating systems could be utilized to implement the administrative system software 200 of the targeted marketing system 100 of the present invention.

Preferably, as shown in FIGS. 1 and 3, an individual client 122, such as a retail or service business or parking facility, operates a client communication device 124, such as a computer, having a client processor 126 for implementing client software 134 that cooperates with the administrative system software 200 to operate the targeted marketing system 100 and a client memory 128, which can include one or more databases. Each client communication device 124 can be connected to a suitable output device 130, such as a computer display, printer, and the like. It should be understood that each client communication device 124 can include any number of different components, peripherals, and other devices. In an embodiment, the client communication device 124 is configured such that it may communicate with the system server or other means, such as by a DSL modem or a cable modem, a T-1 line, ISDN line, or the like, for connecting to the Internet or other networking system for communication with the administrative component 112. The administrative system software 200 utilized by the administrative component 112 preferably includes conventional browser software 202 suitable for communication over the network system 110, such as the Internet, for cooperating with the customer input/output device 104 as well as the client communication devices 124 to permit communication between the administrative component 112 and the customer input/output devices 104 and with the client communication devices 124 to perform the method of the subject invention. Preferably, the administrative system software 200 operates as an interactive, menu and event driven system that uses conventional type of prompt, dialog, and entry windows to guide a customer 102 to enter customer information 132 (FIG. 7) thereby providing an interactive communications interface for facilitating communications and information exchange between customers 102 and the targeted marketing system 100. As used herein, it should be understood that the term “software” refers to any form of programmed machine-readable language or instructions (e.g., object code) that, when loaded or otherwise installed, provides operating instructions to a machine capable of reading those instructions, such as a computer. The administrative system software 200 and browser software 202 of the present invention can be stored or reside on, as well as be loaded or installed from, one or more floppy disks, CD ROM disks, hard disks or any other form of suitable non-volatile electronic storage media. The system software 200 and browser software 202 can also be installed by downloading or other form of remote transmission, such as by using Local or Wide Area Network (LAN or WAN)-based, Internet-based, web-based or other remote downloading or transmission methods.

Preferably, the system software 200 cooperates with the customer's input/output device 104 (FIG. 1) to use conventional type of prompt, dialog, and entry windows to guide a customer 102 to enter customer information 132 thereby providing an interactive communications interface for facilitating communications and information exchange between an individual customer 102 and the targeted advertising and marketing system 100.

As shown, the system server 116 of the administrative component 112 operates to provide an interface between clients 122 using their client communication devices 124 and the targeted marketing system 100, such as through the network system 110, such as the Internet, as well as providing the ability for clients 122 to register onto the system 100 to input, edit, store and retrieve existing advertising or incentives 138; obtain specific customer information 132 and to actively manage a client's account 140 (FIG. 7) stored within the memory 120 of the administrative computer system 114, including in a customer database. It should be understood that a client's account can include client information such as addresses, contact information, incentive requirements (requirements set by the client necessary to be met by a customer to qualify for an incentive), advertising material and incentives that can be offered and transmitted to customers or potential customers for inducing customers or potential customers to go to a client location. It should also be understood that a customer input/output device can include tablets, mobile phones, smart phones, and other similar devices that can interact with the administrative component to register with the targeted marketing system or to enter information, such as through a web-page or an application (APP), or a social media system into the targeted marketing system.

Referring to FIGS. 1, 2 and 3, the administrative system software 200 of the administrative computer system 114 as shown operates to generate a general portal or access 136, such as in the form of an opening web page 204 having one or more windows or fields 206 for receiving customer information 132 from a customer 102 and transmitting the customer information 132 through the network system 110 to the administrative component 112 for storage in the client memory 128. The opening web page 204 can include also include one or more windows or fields 206 for allowing a client 122 to review customer information 132 stored in the client memory 128 or to memory 120 of the administrative computer system 114 and/or to input advertising or incentives 138 into the client's account 140. As shown, customer information 132 inputted into the system 100 and stored in the memory 120 and/or memory 114, such as a data bank, preferably includes, but is not limited to, customer demographic information 142, specific customer data 144, preferably including, but not limited to, names, addresses, phone numbers, Email information, as well as other relevant information, and customer preferences 146.

Referring to FIG. 4, nodes 108 are placed in position, such as but not limited to the entrance or exit of a client location 106, and operate to establish communication with a client communication device 124 when the customer 102 enters or is in a predetermined range of the client location 106 and functions to monitor the arrival and departure of the customer 102. The nodes 108 function to receive short-range wireless communication emitted signals or probe request 12 (such as but not limited to Wi-Fi signals, BLUETOOTH signals, NFC signals, and the like) being emitted from a customer's input/output device 104, such as a smartphone. These emitted signals 12 from the customer input/output device provide customer identification information 148 such as a digital signature or other identifier (i.e. a media access control address (MAC) address), as well as the client location 106 of the node 108 that is receiving the emitted signals 12 and the date and time the emitted signal 12 was received. The customer identification information 148 is then preferably stored in the client memory 128 and transmitted by the client communication device 124 to the administrative component 112 using the network system 110 for storage in the memory 120 of the administrative computer system 114 and for analysis, as described below.

Referring to FIGS. 1-5, in operation, a customer 102 first accesses the targeted marketing system 100 using the customer's input/output device 104 through the portal or access 136, such as through an interactive web-page 204 (e.g. HTML page) generated by the administrative system software 200 and accessible through the a network system 110 such as the Internet. The administrative system software 200 further operates to permit the customer 102 to register with the targeted marketing system 100, such as through the portal or access 136, and to perform the specific operations as more fully described below. The customer 102, using the customer's input/output device 104, obtains access to the system server 116 such as through the Internet, to obtain access to the system's portal or access 136, such as the interactive web-page 204, generated by and hosted by the system server 116. In an embodiment, the system software 200 operates to direct the system server 116 to display an interactive web-page 204 (e.g. HTML page) that provides the customer 102 with various options to input customer information 132. In an embodiment of the invention the interactive web-page 204 includes one or more windows or fields 206 for allowing a customer to register with the targeted marketing system 100 and to enter customer information 132 into the targeted marketing system which is stored in the memory 120 of the administrative computer system 114. It should be understood that customer information 132 preferably includes specific customer data 144 that comprises one or more of the following data: customer's address, phone number, Email address, age, sex, education levels, working address, type of work, marital status, and number of children; and customer preferences 146 that preferably includes a customer's interests, hobbies, preferences (food preferences, restaurant preferences, store preferences, entertainment preferences, social interests,) and other pertinent information).

In an embodiment of the targeted marketing system 100 of the subject invention, as shown in FIGS. 1-6, the system operates such that at least one client 122 having a client location 106 and a client communication device 124 communicates with the administrative component 112 through a network system 110 using the portal or access 136. Preferably, the client location 106 includes at least one node 108 positioned within the client location 106 and operates to communicate with a customer input/output device 104 using a wireless local area network system 110 when the customer 102 enters the specific client location 106. When the customer 102 enters the client location 106 and comes within range of the node 108, preferably within 100 feet of the node, the customer's input/output device 104, such as a smartphone or other Wi-Fi device, transmits an emitted signal 12, such as a probe request, that is received by the node 108. The node 108 operates to detect the emitted signal 12, even if the customer 102 does not connect the input/output device 104 to the wireless networking system 110 at the location 106, provided the customer input/output device 104 is within range of the wireless networking system 110 and is set to automatically emit a signal (probe requests). The emitted signal 12 transmitted by the customer's input/output device 104 and received by the node 108 is transmitted to the client communication device 124 at the client location 106 and to the administrative component 112 of the system 100. Referring to FIGS. 1-8, the administrative computer system 114 of the administrative component 112 operates to use customer information 132 and the customer identification information 148 to identify the specific customer (“target customer”) 150 using a customer listing 154 (a listing of all customers that have registered with the targeted marketing system) and to segment the target customer 150 into a customer type 300. It should be understood that the target customer 150 may be classified in one or more customer types 300 based on the customer information 132 for the target customer 150. In determining the customer type 300, customer information 132 as well as type information 152 is utilized. Preferably, type information 152 includes identification of the specific target customer, the specific client location 106 typically used by the target customer 150, the time and date when the target customer generally enters the specific client location, the duration of stay at the specific client location, the frequency that the target customer uses the specific client location, the purpose or anticipated purpose that the target customer is at the client location. Depending on the customer type 300 that the target customer 150 has been segmented into and specific customer information 132, such as demographics information 142 and the customer preferences 146 previously entered into the targeted marketing system 100 and stored in the memory 120 of the administrative component 112, the administrative component 112 operates to select and transmit an advertisement or an incentive 138, using the clients account 140, directly to the target customer's input/output device 104. It should be understood that using such customer information for the specific customer permits advertising and incentives to be selected that improves the likelihood that the specific customer will utilize the incentive thereby increasing the likelihood that the customer will utilize the client's location on a more frequent basis or to attract potential customers to the client's location.

In one non-limiting exemplary illustration showing the operation of the targeted marketing system 100 of the subject invention, a client location 106, such as a parking facility, receives a customer 102 that enters the client location 106. A node 108 placed within the client location 106 operates to automatically receive an emitted signal 12 (wireless digital signature (probe request)) from the customer's input/output device 104 without the need of the customer taking any action. In an embodiment, the customer's input/output device 124 transmits the emitted signal 12 in the form of a digital signature, to the node 108 which communicates with the client's communication device 124 such that the client processor 126 using the client software 134 functions to compare the emitted signal 12 (digital signature) to a customer listing 154 stored in the client memory 128 of the client communication device 124 to identify the specific customer 102 or determine if the customer 102 is a known customer or a unknown (or first time) customer with the client or at the client's location. The emitted signal 12 is also transmitted to the administrative component 112 which uses the emitted signature 12 to compare with a master customer listing 156 stored in the memory 120 to determine if the customer 102 is a registered or an unregistered customer with the system 100. If the customer 102 is determined to be a registered customer, the customer is identified as a specific (target) customer 150 and the administrative system software 200 operates to segment the target customer 150 into a first customer type 300. In the non-limiting example, a target customer 150 is segmented into a first segmented customer type 300 based on type information 152, such as whether the target customer 150 is a regular customer 166 or non-regular customer 168 at the client location 106, a contract customer 170 at that client location (a customer that has a contract with the parking facility, such as a monthly parker), or a new customer 172 at the client location (FIG. 9). It should be understood that the first segmented type 300 can be further segmented into one or more secondary types 304 based on type information 152 and customer information 132 including information such as events within a predefined area 158 (FIG. 11) or the client location 106 or the length of time the target customer 150 typically parks at the client location 106. Customer segmentation also may be made on other customer information 132 such as customer preferences 146 and customer demographic information 142 (FIG. 7).

The administrative component 112 further operates to analyze each customer 102 based on the customer's segmented type 300 and the redemption rate 184 to create an effectiveness quotient 160 (FIG. 12). It should be understood that by examining the effectiveness quotient 160, the effectiveness (redemption rate 184) of a customer advertising and incentives 138 can be determined and adjusted (inventive adjustment (modification) 186)) to provide the most effective advertising and incentive for attracting customers (including specific customers or specific customer type(s)) and potential customers (including specific potential customers or specific potential customer type(s)) to a client location. For a non-limiting example, preferably the administrative component operates to monitor and determine the redemption rate for each incentive for each customer type and calculates an effectiveness quotient. If the effectiveness quotient falls below a predetermined threshold amount 190, the incentive for the customer type is adjusted (modified). Accordingly, the constant monitoring and adjustment of incentives for particular customer types operates to automatically tailor the advertising and incentives for particular segments of target customers to provide the most effective advertising and/or incentive program.

It should also be understood that non-related clients using the targeted marketing system of the subject invention can cooperate to attract customers and potential customers to their client locations. For example, the administrative component 112 of the targeted marketing system 100 can operate to select client locations 106 that may be of interest to a customer 102, for an example based on a customer preference 146, or a potential customer based on a predefined client attributes 162. For a non-limiting illustration, as shown in FIG. 11, a customer 102 that enters a first client location 174 can receive advertising and incentives 138 for a client 122 or a number of clients based on a client's attribute 162. Such client attributes 162 include, but are not limited to, the distance that a second client location 176 is from a first client location 174; the likelihood that the customer will walk or travel near or past the second client location; and the type of business being offered at the second client location. It should also be understood that the particular advertising and incentive for a particular target customer is further dependent on the segmented customer type 300, for a non-limiting example a first customer type 302 based on the customer's preferences 146 or a second customer type 304 based on the customer's preferences 146.

In another non-limiting exemplary illustration, shown in FIG. 10, the administrative component 112 further operates to transmit messages 164, such as by use of a conventional communication system 178 such as the Internet (Email) and/or texting systems, and other similar systems to customers 102 that are registered in the system. Such messages 164 can be directed to customers 102 (or potential customers) specific targeted customers 150 and can include an advertisement or an incentive 138 or a notification that an incentive is available under certain conditions. In an embodiment, client locations 106 can also post messaging information 180 (such as Email addresses, telephone numbers, texting information and other similar information that can be used by a customer 102 to request an incentive or to communicate with a client 122, such as to make suggestions, to request information.

In another embodiment of the invention the targeted marketing system 100 operates to transmit to client information 132 about customers 102 who have recently registered with the targeted marketing system 100 or has entered a client location 106. In a non-limiting exemplary illustration, when a customer 102 makes a reservation or an appointment at a client location 106, such as a parking facility using a parking reservation system (such as Parking Panda, Spot Hero Park Whiz), upon entering the customer's identification information 148 the administrative component 112 of the targeted marketing system 100 operates to send an incentive 138 (such as a discount) to the customer 102, such as through the customer's input/output device 104, that operates to promote continued or future use of the client location 106 by the customer 102.

It should now be understood that the targeted marketing system operates such that a particular incentive that is transmitted to a customer or potential customer is dependent on the customer information and the customer type. In another embodiment the value of an incentive 138 transmitted to a customer 102 is increased, decreased or maintained the same, or the incentive 138 is adjusted (modified) based on an effectiveness quotient 160 assigned to the customer 102 by the administrative component 112. In one embodiment of the invention the effectiveness quotient 160 is based on the usage of an incentive 138 (such as if the incentive has been used by a specific (target) customer and how soon after receiving the incentive was the incentive redeemed (used), the percentage of customers than have received the incentive and redeemed the incentive, the average amount of time before the incentive was redeemed, the cost associated with the incentive in relation to the use of the incentive, the percentage that the incentive has been used by repeat customers and by new customers, and other such information). In another non-limiting illustration of the operation of the targeted marketing system, the first time a customer enters a client location the system operates to transmit a first incentive having an economic value. The next time the customer enters a client location the system operates to transmit a second incentive having an economic value to the customer. The economic values of the first incentive and the second incentive can be increased, decreased or remains the same. It should also be understood that the incentive and changes to the incentive can be determined by various factors, including customer information, the effectiveness quotient of the incentive as well as various requirements 188 (criteria) set by the client.

It should now be understood, as shown in FIG. 11, that the targeted marketing system 100 of the subject invention allows for a client having a first client location 174, such as a parking facility, to interact with and cooperate with other clients having one or more second client locations 176 (such as unrelated parking facilities, merchant locations, retail stores, restaurants and other similar type of client locations). For a non-limiting exemplary illustration, a first client location 174, such as a parking facility, can notify customers or potential customers that one or more second type of client locations 176 are offering one or more incentives 138. Thus, the administrative component 112 preferably operates such that a customer 102 arriving at a second client location 176 (such as a retail store) will receive an incentive 138 prior to or immediately after arriving at the second client location 176. In another embodiment of the invention, when a customer 102 enters a first client location 174 the administrative component 112 operates to identify all second client locations 176 within a predefined area 158 around the first client location 174. Accordingly, the administrative component can transmit incentives to a customer for encouraging a customer to enter one or more of the second client locations. In addition, second type of clients can offer incentives that encourage a customer or a potential customer to utilize or enter the first client locations (or other second client locations), such as by offering the incentive of parking validation. Accordingly, unrelated clients can cooperate together to provide advertising and incentives to customers and potential customers thereby increasing the effectiveness of their incentives and advertising without significantly increasing associated costs. Further, by cooperating together incentives will have a significant synergetic effect.

For a non-limiting exemplary illustration of an embodiment of the invention, a first client location is in the form of a parking facility where several different customer types have entered. For example, using customer information, the administrative component operates to identify a customer and segment the customer into one or more types, such as for example one customer type can be a short term parker (those that are there for the day and pull a ticket for parking upon entering the parking facility) and another customer type can be segmented as a contract customer (contract parker—those that pay a monthly fee to park at the client location and have various access rights with regard to the customer location, i.e. can park every day, Monday-Friday during a certain time period etc.). In an embodiment the incentives given to a customer can vary depending on each customer type. Further, customer information and the customer's segmented customer type is transmitted to clients, such as clients within a predefined area, to permit clients to enter incentives for each customer type that is transmitted to the customer. For example, a client can provide an incentive to a contact customer, such as payment of their monthly fee at the customer location. In another non-limiting illustration, a customer enters a customer location such as a parking facility where the customer is a contract customer (contract parker). Upon entering the customer location (first client location) the administrative component sends an incentive to the customer's input/output device to encourage the customer to visit a second client location. If the customer does visit the second client location (and meets any requirements the client operating the second client location requires to receive the incentive), the customer can redeem the incentive (for example the client operating the second location can provide an incentive such as paying the monthly parking fee at the first client location for the customer). It should be understood that in an embodiment of the invention the targeted marketing system of the subject invention operates to permit specific incentives to be transmitted to a customer's input/output device based on a customer's actions. In one non-limiting illustration of the subject invention the incentive can vary based on the action of the customer such as if the customer enters a client location and meets certain requirements (i.e. the customer merely enters the client location) the customer receives an incentive. If the customer meets other requirements (i.e. the customer enters the client location and makes a purchase) a different incentive is awarded. In another embodiment the incentives awarded can be maintained and monitored by the administrative component (for example stored as part of the customer information) such that as the customer meets more of the requirements provided by a client the incentive available to the customer increases. In a non-limiting illustration, as a customer frequents a client location the incentive increases in value and can be redeemed by the customer at any time or at a predefined time.

It should be apparent to one skilled in the art that the targeted marking system of the subject invention operates to permit unrelated clients to cooperate together to provide customers with incentives that operate together to synergistically increase the likelihood that the customer will enter the locations of one or more clients. It should also now be apparent that clients can cooperate together using the targeted marketing system of the subject invention without the need to directly contact each other or sharing sensitive information. It should also now be apparent that one specific incentive can be created and transmitted to a type of customer at a client location and a different specific incentive can be transmitted to a second type of customer. It should also now be apparent that the targeted marketing system of the subject invention operates to calculate one or more effectiveness quotients that reflect the effectiveness of the specific incentives as well as the economic benefits of client cooperation with regard to the incentives. Further, it should now be apparent that in an embodiment of the invention the administrative component operates to keep track of incentives that have been earned by a customer and such incentives can be redeemed immediately or, depending on client requirements, earned after a period of time. For example a customer (such as a short term parker can be earned and redeemed in close proximity of the time the customer entered the client location (parking facility) or a customer (such as a contract parker can grow the value of an incentive (for example an incentive towards their monthly parking fees) by entering other client locations over a predefined period of time.

It should be apparent that the targeted marketing system of the subject invention operates to permit a client location to utilize a single interface (node and/or client communication device) that operate to transmit an incentive (such as a parking validation or coupon) for multiple customer locations (parking facilities) whether or not the client locations are owned or operated by the same client. It should also now be apparent that the subject invention operates to permit incentives to be dynamic in nature, such as permitting specific incentives to be transmitted to specific target customers or to provide incentives that are time limited. In addition, incentives can be tailored based on customer information, customer type (such as old or new or potential customers) or other segmentation. For a non-limiting example, potential customers may receive larger incentives or time sensitive incentives that increase the likelihood that the customer will try or become a regular customer.

It should also now be understood that clients can utilize the targeted marketing system of the subject invention thereby allowing various clients to participate in a common marketing system regardless of the client's technology, ownership, management of client location. Accordingly, the subject invention is a targeted marketing system for use by one or more clients and one or more customers and comprises one or more clients each having a client location and a client communication device, one or more customers each having a customer input/output device, and an administrative component having a computer system. Each client location has at least one node that operates to receive an wireless emitted signal from a customer input/output device, and the emitted signal is used to identify the customer as a target customer. The client communication device operates to transmit to the administrative component customer identification information and the administrative component operates to use the customer information to segment each of the one or more customers into a customer type. The administrative component further operates to transmit at least one incentive to the customer input/output device of a target customer based on the customer type. In an embodiment the customer information includes information selected from a list consisting of the specific client location being used by the customer, the time and date when the customer entered the client location, the frequency that the customer uses the client location, the purpose or anticipated purpose that the customer is at the client location, demographics information, and customer preferences. In another embodiment of the invention the administrative component further operates to identify one or more second client locations located along a selected path of travel of a customer traveling from a first client location. In another embodiment the administrative component further operates to identify one or more second client locations that relate to the customer preferences. In an embodiment at least one incentive directed to the customer operates to provide an incentive to the customer to enter a first client location or a second client location. The administrative component further operates to collect customer information and transmits the customer information to one or more clients. In operation of an embodiment the administrative component identifies various events scheduled to be held within a defined area during a selected period of time and identifies all customer locations within the defined area and transmits an incentive to a customer input/output device for all customers having a customer preference that relates to the various events. In another embodiment of the invention the administrative component operates to segment each of the one or more customers into customer type selected from a list consisting of unregistered customer groups, registered customer groups, unregistered variable customer groups, or registered variable customer groups and each incentive is dependent on the segmented group.

It should also now be apparent that the targeted marketing system of the subject invention allows for customers at a first client location, such as a parking facility, to be notified of participating second client locations (such as retail stores, restaurants that are offering an incentive, such as parking validation, as an incentive for a customer's patronage after the customer has arrived at the first client location (parking facility) and before walking into a second client location by happen stance. It should also now be apparent that the targeted marking system permits customer locations to have a single interface, such as producing parking validations at multiple client locations (parking facilities). Further, incentives can be dynamic allowing for standard incentives to be generally communicated to customers or potential customers as well as offering specific incentives to specific (targeted) customers based on the customer's type. For a non-limiting illustration, incentives can be in the form of points that are assigned to a customer for the customer's type based on various customer activity (specific customer data) such as the customer's frequency and/or duration of stay at a client location, or for the customer logging into another system, such as used by other clients, or based on customer information such as demographic information and/or customer preferences, or customer data such as attendance at an event, or entering other client locations, or spending amounts at a client location, and other such activities. It should be understood that such incentives can also be determined based on the client attributes such as specific customer location, the current day or date, competition with other locations, and a client's need to increase business.

It should also now be apparent to one skilled in the art that the targeted marketing system of the subject invention that the system also operates effectively with the increase in use of autonomous vehicles. Such autonomous vehicles once arriving at a location, such as a parking facility, can be recognized and interaction with the location will be automatic, such as by wireless systems that interact with short-range wireless communication signals utilized by the autonomous vehicles such as those emitted by a customer's input/output device as described above. In addition, it should be understood that the targeted marketing system of the subject invention allows registered customers to be made aware of available incentives based on the customer's activity (desired end location) and not based solely on where the autonomous vehicle parks and also permits an incentive such as parking validation to be utilized towards payment of the autonomous vehicle's parking no matter what parking facility is used and without the need of a customer being in the vehicle. In alternative embodiments that can be practiced alone or in combination with the embodiments discussed above, further improvements can be made in addition to the disclosed targeted marketing system. In an embodiment a parking facility system benefit from a parking and validation system as disclosed herein that operated in conjunction with the disclosed targeted marketing system. In an embodiment the parking and validation system disclosed herein can operate independently of the targeted marketing system described above.

The parking and validation systems and methods disclosed herein can utilize the communication and computer components described above, including the administrative component 112 and the network system 110 that can facilitate the system between customers 102 and clients 122 via their respective input/output devices 104 and communications devices 124. Likewise, the parking and validation system can utilize browser software 202, systems servers 116, portals 136 and memory 120 in a manner as described above. Any differences in operation of the parking and validation system with respect to the targeted marketing system are differences of description of certain embodiments, and the differences are not to be understood as excluding operation of the parking and validation system by any of the components of the system and method of the targeted marketing system above.

A parking and validation system can be described in four components. Each of the four components can operate independently or in combination with other components, and are described separately for clarity. The four components include: (1) monthly validation; (2) validation delivery; (3) rewards discounts; and, (4) customer segmentation. Again, while described separately, the four components can be combined, partially combined, or used separately, and the descriptions below are to be understood as non-limiting.

For each of the components of a parking and validation system, the description includes customers 102 and clients 122 as described above. However, whereas above clients were described as “individual client 122, such as a retail or service business or parking facility,” for the following description a distinction is more clearly delineated between “parking facility clients” and “retail or service business clients”. Thus, referring to FIG. 13, which is slightly modified from FIG. 1, a parking and validation system 100A is shown, and for the purposes of describing the parking and validation system 100A the term “parking client 122A” refers to a parking facility client and the term “business client 122B” refers to a retail or service business client. Unless otherwise noted, “client location” refers to a location of a parking facility, i.e., a location of a parking client 122A. Likewise, FIG. 14 shows the administrative component 112 as in FIG. 2 but slightly modified to show a communication device 124 that can be a communication device 124A for parking client 122A or communication device 124B for business client 122B.

FIG. 15 illustrates in more detail a representative computing device 400 that can be the customer 102 input/output device 104, or a communication device 124A or 124B of a parking client 122A or business client 122B, respectively.

The processes described herein can be performed on or between one or more computing devices 400 of the parking client, the business client, and the customer. A computing device 400 can be a server, a computing device that is integrated with other systems or subsystems, a mobile computing device, a cloud-based computing capability, and so forth. For example, the computing device 400 depicted in FIG. 15 can be a cluster of servers that each execute one or more of the software modules of administrative component 112, including memory 120 and database 110. The computing device 400 can be any suitable computing device as would be understood in the art, including without limitation, a custom chip, an embedded processing device, a tablet computing device, a personal data assistant (PDA), a desktop, a laptop, a microcomputer, a minicomputer, a server, a mainframe, or any other suitable programmable device. In various embodiments disclosed herein, a single component can be replaced by multiple components and multiple components can be replaced by a single component to perform a given function or functions. Except where such substitution would not be operative, such substitution is within the intended scope of the embodiments.

Each computing device 400 can include one or more processors 402 that can be any suitable type of processing unit, for example a general purpose central processing unit (CPU), a reduced instruction set computer (RISC), a processor that has a pipeline or multiple processing capability including having multiple cores, a complex instruction set computer (CISC), a digital signal processor (DSP), an application specific integrated circuits (ASIC), a programmable logic devices (PLD), and a field programmable gate array (FPGA), among others. The computing resources can also include distributed computing devices, cloud computing resources, and virtual computing resources in general.

The computing device 400 also includes one or more memories 406, for example read only memory (ROM), random access memory (RAM), cache memory associated with the processor 202, or other memories such as dynamic RAM (DRAM), static ram (SRAM), programmable ROM (PROM), electrically erasable PROM (EEPROM), flash memory, a removable memory card or disk, a solid state drive, and so forth. The computing device 400 also includes storage media such as a storage device that can be configured to have multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or BluRay™ disk, and so forth. Storage media such as flash drives, solid state hard drives, redundant array of individual disks (RAID), virtual drives, networked drives and other memory means including storage media on the processor 202, or memories 206 are also contemplated as storage devices. It can be appreciated that such memory can be internal or external with respect to operation of the disclosed embodiments. It can be appreciated that certain portions of the processes described herein can be performed using instructions stored on a computer-readable medium or media that direct a computer system to perform the process steps. Non-transitory computer-readable media, as used herein, comprises all computer-readable media except for transitory, propagating signals.

Network and communication interfaces 412 can be configured to transmit to, or receive data from, other computing devices 400 across a network 110. The network and communication interfaces 412 can be an Ethernet interface, a radio interface, a Universal Serial Bus (USB) interface, or any other suitable communications interface and can include receivers, transmitter, and transceivers. For purposes of clarity, a transceiver can be referred to as a receiver or a transmitter when referring to only the input or only the output functionality of the transceiver. Example communication interfaces 412 can include wired data transmission links such as Ethernet and TCP/IP. The communication interfaces 412 can include wireless protocols for interfacing with private or public networks 416. For example, the network and communication interfaces 412 and protocols can include interfaces for communicating with private wireless networks 416 such as a Wi-Fi network, one of the IEEE 802.11x family of networks, or another suitable wireless network. The network and communication interfaces 412 can include interfaces and protocols for communicating with public wireless networks 416, using for example wireless protocols used by cellular network providers, including LTE (Long Term Evolution), Code Division Multiple Access (CDMA), and Global System for Mobile Communications (GSM). A computing device 400 can use network and communication interfaces 412 to communicate with hardware modules such as a database or data store, or one or more servers or other networked computing resources. Data can be encrypted or protected from unauthorized access, for example by using secure sockets, virtual private networks, and so forth.

Mobile computing devices can include inertial components 408 and global positioning systems components (GPS components 410). The inertial components 408 and GPS components 410 can determine the terrestrial position of the mobile computing devices. Mobile computing devices can use the inertial components 408 and GPS components 410 in combination with radio transmissions received via the network and communication interfaces 412 to accurately determine the position of a mobile computing device. In an embodiment, the position information can be used to determine the position of a customer 102.

In various configurations, the computing device 400 can include a system bus 414 for interconnecting the various components of the computing device 400, or the computing device 400 can be integrated into one or more chips such as programmable logic device or application specific integrated circuit (ASIC). The system bus 414 can include a memory controller, a local bus, or a peripheral bus for supporting input and output devices 404, and communication interfaces 412. Example input and output devices 404 include keyboards, keypads, gesture or graphical input devices, motion input devices, touchscreen interfaces, one or more displays, audio units, voice recognition units, vibratory devices, computer mice, and any other suitable user interface.

The processor 402 and memory 406 can include nonvolatile memory for storing computer-readable instructions, data, data structures, program modules, code, microcode, and other software components for storing the computer-readable instructions in non-transitory computer-readable mediums in connection with the other hardware components for carrying out the methodologies described herein. Software components can include source code, compiled code, interpreted code, executable code, static code, dynamic code, encrypted code, or any other suitable type of code or computer instructions implemented using any suitable high-level, low-level, object-oriented, visual, compiled, or interpreted programming language.

As discussed above, the present disclosure relates to parking lots for vehicles, referred to herein as a “parking facilities.” A parking facility can be one parking lot or a system of parking lots under common ownership or common operation. A parking facility can administer the parking and validation system disclosed herein for customers who pay for parking spaces on a daily, weekly, monthly, or annual basis. The system and method disclosed herein is useful for customers who pay for more than one day's parking, for example, for those entering into monthly parking contracts. For simplicity of description, customers are considered herein to be parkers who pay for multiple days, e.g., a month, of parking. Customers can, therefore, be “monthly parkers” and the customer is described as entering into a contract with a parking facility in which the customer pays the parking facility on regular intervals, e.g., monthly, for access to the parking facility.

### Monthly Validation

Referring now to FIG. 16, an example flow diagram of one embodiment of a parking and validation system 100A is presented. The illustrated embodiment solves the problem of validating monthly parkers by providing a technical solution for enabling at least of portion of a monthly parker's fees to the parking facility to be discounted, paid, credited, or reimbursed by another. In general, it is not critical to the present development whether the benefit a customer experiences is in the form of a discount to his monthly payment obligation to a parking facility, a partial or full payment of his monthly payment obligation, a full or partial credit of his monthly payment obligation, or a full or partial reimbursement of his payment to a parking facility. In every aspect, the customer's payment obligation is validated in some form, and is referred to in operation as a “discount”. Further, the term “monthly” is not to be limiting and is used for convenience, as many parking contracts are based on a monthly basis. However, the system and method of the present disclosure can be utilized for any time period, including weekly, and annually.

Referring to FIG. 16, a method of parking and validation can start at Step 1 with a customer 102 entering into a contract with a parking client 122A for routine usage of a parking facility. The customer 102 can sign up for parking in the parking facility by using the user interface of the parking and validation system 100A presented to the computing device 104 of the customer 102. For example, the user interface can be presented via the portal 136 on a dedicated application over the network system 110, such as a mobile app, and can be presented in one or more web pages served to the computing device 104 of the customer 102. In an embodiment, a customer 102 can use the user interface module portal 136 of the parking and validation system 100A and download an app onto the customer computing device 202. The app can include instructions for signing up for monthly parking and can, as well, facilitate the sending to the customer computing device 202 a credential 220 that can reside on the customer computing device, such as a digital credential.

In an embodiment, a customer can use a smartphone on which is sent a link to download an app that has a live credential. When entering a parking facility, a customer can use the live credential, for example via Bluetooth communication, to gain entry into a parking facility. The live credential can be compared to a database of customer accounts and permit entry, and can, as well, be associated with the discount database as described herein for validating and receiving validation of parking, as disclosed herein. The advantage of utilizing a live credential on an electronic device such as a smartphone is that the credential can be multiply-authenticated, and the credential cannot be passed onto non-customers. For example, as disclosed herein, the credential can be associated with a MAC address which can also be associated with a license plate number for a vehicle. The system, therefore, can be set up to permit access to a parking facility only to the person with the credential and with the vehicle having the identified license plate number. In an embodiment, therefore, the system and method of the present disclosure can include license plate recognition technology as is known in the art.

The credential 220 can be registered with the parking and validation system 100A and or/the parking client 122A and the customer information including information regarding the credential 204 can be associated with a unique ID and stored in a database in the memory 120 of the administrative component 112 of parking and validation system 100A. The database of memory 120 can be considered a plurality of databases, including a customer database 202 storing client information 132, customer identification information 148, customer listing 154, type information 152, and customer type 300. The system can also have a discount awards database 212 that can hold, for example, business client discount offers and redemptions of such offers.

At Step 2, a business client 122B can record a transaction eligible to validate all or a portion of the customer's 102 parking fee as determined by the particular discount offered by the business client 122B. Business client 122B can offer a good or service, which if the customer purchases, the business client provides a discount to the customer that can be redeemed to reduce or completely cover the customer's monthly parking fee.

In an embodiment, the business client 122B can interface with the parking and validation system 100A via middleware 216 to provide information related to discounts and purchase criteria. The parking and validation system 100A can be notified of events that trigger a discount being applied to a customer 102. Thus, in an embodiment, when a qualifying transaction occurs, information including the identity of a customer 102 can be transmitted from a business client 122B to the parking and validation system. The parking and validation system 100A can then locate, identify, and otherwise associate the information sent with the customer and can facilitate the crediting of the customer's account, as disclosed herein.

Parking validation can be achieved in a plurality of ways. In an example, as shown in FIG. 16, the business client 122B can interface with the parking and validation system via the network 110 to provide such discounts to customers 102. Such interfacing can occur at Step 7 through middleware 216 that connects and facilitates communication between a business client 122B point of sale system 214 and the parking and validation system 100A, including the communication device 124A of parking client 122A. A point of sale system 214 of business client 122B can communicate directly, including via middleware 216, to record the discount to the memory 120 of the administrative component 112, including in discount database 212.

In an alternative embodiment, as shown in FIG. 17, at Step 3 the business client 122B can provide to customer 102 a discount voucher 218 that can be in the form of a receipt or coupon that the customer 102 utilizes to redeem the discount or have the discount accrue to his or her account in the discount database 212. In an embodiment, for example, the business client's point of sale system can generate a receipt that includes validation information. Discount voucher 218 can be paper or digital and can include any of known data carriers, including RFID, UHF, sound waves, codes, bar codes, QR codes and the like to aid in redemption. At Step 5, the customer 102 can present the discount voucher 218, by scanning the code or entering in a discount code in the input output device, and this will cause the discount to be applied in the discount database that can be applied toward the monthly parking fee. The customer 102 can interface at Step 5 through middleware 216 that connects and facilitates communication between a customer's 102 communication device 104 and the parking and validation system 100A.

The customer 102 can redeem any and all accrued discounts to be applied to his or her parking fee by interfacing with parking and validation system 100A to cause any and all discounts to be applied. As shown in FIG. 18, a customer 102 can interface with middleware 216 that is also interfaced with an accounting system in a Parking Access and Revenue Control System (PARCS) 222. PARCS are real time computerized parking systems for transient and credentialed customers. Available in varying levels of functionality and complexity, these systems allow parking owners and operators to control access and collect parking revenues from users. The parking and validation system 100A can utilize the accounting system of a PARCS 222 to charge the business client 122B for the relevant discounts. For example, the middleware 216 can operate to transfer funds from a business client 122B to a parking client 122A. The middleware 216 can also show an accounting of amounts received and credited and can also account for total amount owed and allow for payment of any remaining balances. Payment can be made by known methods, such as electronic transfer, ACH, check, and cash.

In an embodiment, validation benefits can be bundled with other benefits, such as partial or full payment for entertainment services, car wash services, auto repair services, and the like.

In an embodiment, validation benefits can be dynamically offered based upon criteria such the identity of the customer 102, the time of day of entry into a parking facility, day of the week, frequency of entry and exit of the parking facility, the frequency with which the customer has purchased goods and services in the past, and like criteria.

### Validation Delivery

Various systems and methods can be utilized within the parking and validation system 100A to provide a parking validation for a customer 102. In an embodiment, as shown in FIG. 19, a system and method for parking validation can start with a customer 102 interfacing with the parking and validation system 100A, such as through a PARCS system 222 associated with a parking client 122A to get an entry credential, such as a ticket 226. Interfacing can include pulling a physical ticket from a machine at the entry to a parking facility, entering a license plate number, or otherwise inputting data that results in a ticket 226 that can include a unique identifier.

Interfacing with the parking and validation system 100A can be, in general, any entry transaction initiated by the presence of a customer at the parking facility. In an embodiment, interfacing can include interacting with an entry credential dispenser at a parking entry station. In an embodiment, the parking entry station can be a ticket dispensing station that a customer can drive up to, take a credential (e.g., a paper ticket), wait for a barrier gate to rise, and drive into the parking facility. In an embodiment, the parking entry station can be approached and interfaced with by a customer on foot. In an embodiment, interfacing can be initiated by detection of an object associated with a customer, such as a license plate or the customer's computing device. In an embodiment, an entry credential can be selected from paper tickets and virtual images or signals via any of known data carriers, including RFID, UHF, sound waves, codes, bar codes, QR codes and the like. In an embodiment, entry be facilitated in the absence of any physical entry credential dispenser and/or any physical barrier. In non-limiting embodiments disclosed herein, an entry credential in the form of a ticket is used for the purpose of illustrating the systems and methods of the present disclosure.

The delivery of a ticket 226 and any subsequent use of the ticket, including for validation, can be stored in a transaction history database in memory 120 or in the cloud. The ticket 226 can be delivered via electronic means including over Wi-Fi, and by email, app-based systems, Facebook, messenger, snap chat, and the like.

The parking and validation system 100A can confirm, including in real time, via middleware 216 with information from the PARCS system that the ticket 226 delivered to customer 102 is open in the system and available for validation. A parking validation can then be delivered to the customer 102 by any known method, including by electronic communication. Importantly, the system and method herein ties a specific customer with the validation. That is, the system can electronically deliver a validation credential to a specific customer, and can create account information for that customer based upon the delivery of the validation credential and can further build out customer segmentation by confirming usage of the validation.

In an embodiment, the ticket 226 obtained by customer 102 can be validated in the PARCS system electronically and can then be reproduced by the parking and validation system 100A and delivered electronically to the customer 102.

In an embodiment, the delivery information can be stored in memory 120, including in a database.

In an embodiment, the administrative computer system 112 of the parking and validation system 100A can use the customer information to create or add to a customer profile, including, for example, client information 132, customer identification information 148, customer listing 154, type information 152, and customer type 300.

Referring to FIG. 20, there is shown another example of validation delivery. In this embodiment, a customer 102 having a ticket 226 that could have been issued by a PARCS system 222 can interact with a validator 228, which can be, for example, a business client 122B. The customer 102 can patronize the business of a business client 122B, for example, and the business client 122B as the validator 228, can interact with the middleware 216 generate and deliver electronically a validation credential to the customer 102. The customer can then redeem the validation credential by, for example, scanning the ticket 226 received from the PARCS system, and then scanning the validation credential delivered by the validator 228 via the middleware 216. “Scanning” includes scanning via a reader, such as with bar codes, as well as other forms of image capture and communication, as is known in the art. Scanning could also mean scanning the ticket that was issued by the PARCS system first at the PARCS system scanner and then presenting the credential that was delivered by the middleware system to the PARCS system.

In an embodiment, validation delivery can also be achieved by the parking and validation system 100A via the middleware in a method as described above with respect to FIG. 16. That is, the parking and validation system 100A can reconcile the client database 202 and the discount database 212 and validate the customer's 102 account by the amount accrued to the customer 102.

### Rewards System

In addition to the validation systems and methods described above, the parking and validation system 100A facilitate discounts to a customer 102 who purchases a threshold amount of goods or services from a business client 122B. The system flow and framework can be described in terms similar to those described above with reference to FIGS. 16 and 17. The system and method described with reference to FIGS. 16 and 17 can be made to include multiple discounts from multiple business clients that can accrue additively to the customer's account.

In an embodiment, for example, a customer 102 can purchase a threshold amount of goods or services offered by a first client business 122B, in which the first business client 122B awards a first parking discount to the customer 102, which can be a discount per hour, week, month, or other defined period. The first parking discount can be stored in the customer database for the customer. The same customer can then make another purchase from the first client of a threshold amount of goods or services, resulting in a second parking discount being awarded to the customer, the second parking discount amount being stored with and added to the first parking discount in the customer database for the customer. In like manner, the same customer can make a purchase of a threshold amount of goods or services from the first client, second client, . . . to the nth client, and, in turn continue to accrue third, fourth, . . . to nth awards that can be stored with and added to the first parking discount in the customer database for the customer.

In an embodiment, the parking and validation system 100A can operate such that the method of generating a discount for parking in exchange for the purchase of one or more discount-triggering items by a customer 102 from a client business 122B includes that the client business 122B interfaces from its point of sale system 214 with middleware 216 to associate the discount to the customer 102 in the customer database 202, and which the customer can then redeem as discussed above with respect to FIG. 17.

In an embodiment, the parking and validation system 100A can operate such that the method of generating a discount for parking in exchange for the purchase of one or more discount-triggering items by a customer 102 from a client business 122B includes that the client business 122B provides to the customer 102 a discount voucher 218, that the customer can then redeem as discussed above with respect to FIG. 17.

The customer can be notified of his accrued awards in his discount account. In an embodiment, the customer can check his or her computing device 104 to access the user interface module portal 136 of the parking and validation system 100A. In an embodiment, a signal from the customer's computing device 104, such as the MAC address, can be detected by one or more nodes of the parking facility, and the parking and validation system 100A can cause to be displayed on the customer's computing device 104 a notice the available discounts to that customer.

In general, the signal from the customer's computing device can be any unique signal and can be considered to be a device fingerprint. In non-limiting embodiments herein a MAC address is utilized for a signal. Other identifying features of the customer's computing device can be utilized, such as a client system's TCP/IP configuration, OS fingerprint, IEEE 802.11 (wireless) settings, hardware clock skew, and combinations thereof. The customer signal can be actively assembled, such as by querying the customer for information, installing an executable code directly on the customer communication device 104, installing a cookie file, installing or recording attributes such as unique serial numbers assigned to the customer communication device software or hardware. If necessary, the parking and validation system 100A can employ JavaScript or other client-side scripting language for the harvesting of parameters and/or the enabling of a device fingerprint, with the intention of establishing a stable, unique device fingerprint. The device fingerprint can be solely device specific, that is, the device fingerprint can consist solely of customer computing device-specific information or parameters and not any user-, or parking facility server-specified information in the form of passwords, cookies, or the like.

The customer can select to fully or partially exercise his discounts, such that his parking fee for the hour, day, week, month or other defined period is reduced accordingly.

Referring now to FIG. 21, an embodiment of a validation reward system is described for a customer having an award or an accrued award for purchasing threshold amounts of goods and services from one or more business clients 122B. At Step 1 a customer 102 interacts at a parking column 230 prior to exiting a parking client 122A. Before or after the customer 102 reaches the payment column, at Steps 2 and 3 the customer 102 can have delivered electronically to his or her communication device 104 a discount amount and/or credential from the administrative component 112 of the parking and validation system 100A, such as via middleware 216 that accesses the customer database 202 and discount database 212. The calculating of the amount owed for the parking session can initially be accomplished at Step 4 by the PARCS system 222 and can be displayed on a PARCS system interface 234. Before or after the display on the PARCS system interface, at Step 5, the customer 102 can, when prompted for payment, scan the discount provided by the administrative component 112. The PARCS system can then apply the discount, e.g., the discount per hour, day, week or month, to the parking session. If the validation is not 100% of the amount owed, then the customer can be prompted to pay the remaining amount via the PARCS system. At this point, at Step 7, a parking gate 236 can rise and permit the customer 102 to leave the parking facility.

In an embodiment, the delivery at Step 3 of a credential can be accomplished any known means, i.e., any data carrier, including by email or text, and the credential can be a barcode, QR code, or other image that can be detected at Step 5 by the PARCS system.

In an embodiment, the validation amount reported by the PARCS system can be the amount stored as a discount from a first business client as a per hour, per day, per week, or per month discount, and the discount can be stored in the system memory.

In an embodiment, the validation amount reported by the PARCS system can be the total amount stored as the addition of discounts from a first, second, . . . nth business client as a per hour, per day, per week, or per month discount, and the discount can be stored in the discount database.

In an embodiment, a notification to the customer from a parking client 122A of available discounts can be made by transmission from the parking and validation system 100A to the customer's communication device 104. This notification can be made to a customer based on the business client's knowledge through geo-location or other web-based application that the customer has entered a parking facility. Each facility can have a ticketing or credentialing format that is specific to the location. The business client 122A can check that the customer 102 has validation credits accrued, and can offer via a web-based notification, text, message or other to the customer a chance to use these credits. If the customer wishes to use his or her credits, the parking client 122A can send to the customer properly formatted credentials to use at the parking facility in which the customer is parked. In this manner, the parking and validation system 100A permits validation credit to be redeemed across technology platforms in disparate parking systems. One of the advantages of the system is that the parking and validation system allows the vendor business clients in the area that are participating to reward the parking customer at all participating garages without a predefined relationship. This can be done without the parking customer deciding anything.

Referring now to FIG. 22, there is shown another embodiment of payment for validation rewards. Similar to the embodiment described with respect to FIG. 21, at Step 1 a customer 102 interacts at a parking column 230 prior to exiting a parking client 122A. Before or after the customer 102 reaches the payment column, at Steps 2 and 3 the customer 102 can have delivered electronically to his or her communication device 104 a discount amount and/or credential from the administrative component 112 of the parking and validation system 100A, such as via middleware 216 that accesses the customer database 202 and discount database 212. At Step 4 the customer 102 can, when prompted for payment, scan the discount provided by the administrative component 112 and, if necessary, pay any remaining balance. At Step 5, the PARCS system receives the discount, e.g., the discount per hour, day, week or month, to the parking session via the middleware 216, and at Step 6 a parking gate 236 can rise and permit the customer 102 to leave the parking facility. At Step 7, the PARCS system reports and reconciles the discount amount with the parking and validation system 100A via middleware 216.

In the illustrated embodiments for validation rewards, any discounts can be totaled and billed to the responsible business clients 122B. Payment by business clients to parking clients can be facilitated by middleware 216 by methods known in the art.

In an embodiment, if an amount invoiced from a business client 122B by middleware 216 results in an overpayment, it can be considered as a prepayment by the business client 122B and debited as discounts are taken by customers.

In an embodiment, the system and methods described above can be practiced in the following manner. The system can calculate a cumulative total of purchase by a customer over a period of time, and award a first discount when the cumulative total of purchases is at least a first threshold amount. A second discount can be awarded when the cumulative total of purchases reaches at least a second threshold amount. An nth discount can be awarded when the cumulative total of purchases reaches at least an nth threshold amount. The discount can be paid to the customer and invoiced to the relevant clients as described in the various embodiments above.

The process of awarding, storing, and adding the discounts can be performed by a processor associated with a point of sale system at a retail business client 122B having a cross agreement with a parking facility parking client 122A. A middleware provider can discount a parking fee in exchange for a customer 102 purchasing at least a first or second threshold amount of goods and services from the retail business client 122B.

The process of awarding, storing, and adding the discounts can be performed by a processor associated with a point of sale system at a retail business client.

The process of awarding, storing, and adding the discounts can be performed by a processor associated with a point of sale system at first business client and a second business client. The first and second business clients can have a cross-marketing agreement such that the sale of goods or services form the first business client can accrue to the customer as discounts for goods or services from the second business client. For example, the first business client can be a parking facility and the second business client can be a retail merchant different from the parking facility. The parking facility can offer discounted sale of parking based on a customer purchasing a threshold amount of goods or services from the retail merchant second business client.

In an embodiment, the system can, prior to applying a customer discount, add a second discount (per second threshold purchase, e.g., of fuel) to a first discount (per first threshold purchase, e.g., of fuel). If the total discount exceeds a maximum allowable discount, as defined by the parking and validation system 100A, the system can limit the total discount paid to the customer to the maximum allowable amount.

In an embodiment, in a parking and validation system 100A, the total number of units of the cost of parking to which a total discount can be applied is limited, so that a maximum allowed financial discount is not exceeded.

Generally, the operations described in process blocks and decision blocks 502 through 526 can be performed in any order, as would be understood by one of ordinary skill in the art.

### Segmentation

In addition to the process described above, the parking and validation system 100A can perform and facilitate other functions. For example, the parking and validation system 100A can collect information related to customers and potential customers, such as patterns and habits of parking, e.g., in one or more parking facilities of parking clients, and habits and patterns of purchase from participating business clients. In this manner, the parking and validation system can improve both the customer's experience and the client's experience by providing a system and method by which all parties can connect, such as through push notifications from either a business client or the parking client to a customer.

In an embodiment, the parking and validation system 100A can be configured to identify customers and potential customers who may or may not be signed up with the system with customer information entered into customer database 112. In this embodiment, the parking and validation system 100A can build customer profiles based on collectable customer data, for example, data collected from potential customer's computing devices.

As indicated in the Venn diagram in FIG. 23, the parking and validation system 100A can identify potential customers and can facilitate the conversion of potential customers into customers. In an embodiment, a parking client 122A provides a ticket to a new customer upon entry to the parking facility. The new customer can then be presented with an opportunity to sign up with the parking facility for validation rewards. Sign up can be via the network system 110 by use of a smartphone, for example. Sign up can also be via a social network or other established online account. Signing up can result in an immediate validation credit that the customer can redeem upon exit of the parking facility. The parking facility that offered the discount can also be connected to the PARCS system that ties information from the parking system point of sale into various customer information, such as social media accounts, credit card information, and license plate information. In an embodiment a camera can be situated in the entry or exit lane to image a license plate, and convert the license plate information via optical character recognition technology. For example, open source license plate recognition (OpenALPR) can be used. The system can then associate the ticket with the transaction, including the license plate number and other customer data.

Referring back to FIG. 23, the outer circle of the Venn diagram includes within it all the possible potential customers identifiable by the parking and validation system. Identification can be by detection of Wi-Fi signals and/or MAC addresses broadcast from the computing devices, which signals can be picked up by a receiving access point of the parking facility, i.e., a “node” as described above, and as illustrated in FIG. 25. A node can be a Wi-Fi or Bluetooth receiver that can receive any of information broadcast from a computing device, and is disclosed herein in the context of receiving MAC addresses. However, it is noted that there is value to detecting Bluetooth signals; for example, Bluetooth in receive mode can detect the name of a computing device. The nodes can detect not only MAC addresses, but can also detect time of signal reception, which can help segment transient signals, and signal strength, which can be an indication of proximity of a computing device to a node. Multiple nodes can also be utilized to detect the location of a MAC address by trilateration, as described below.

Certain MAC addresses in the region 500 are considered passers by in relation to a parking facility due to one more of: the time a signal is detected, the signal strength, and the location as determined by trilateration. Within a parking facility, in addition to location determined by trilateration, MAC addresses can be attributed to one or more of the segments identified as contract parkers and their passengers 502, and transient parkers 504, including event parkers 506.

In the parking and validation system 100A of the present disclosure, potential customers can be segmented based in part on detected behavior. For example, a MAC address that is detected to be within a parking facility at least 14 days in a month can be considered to be a contract parker, and the MAC addresses can be recorded with other information gathered and on file with the parking facility, such as a license plate number and the name, address, and contact information of the vehicle driver. In addition, such contract parkers can have passengers, whose MAC addresses can also be detected and recorded.

MAC addresses that are detected and located within a parking facility less than 14 days in a month can be considered transient parkers 504. MAC addresses that are detected on weekends can also be considered transient parkers 504. Transient parkers who are detected at the times of known events, such as sports events and concerts, can be segmented as event parkers. Such parkers can be marketed to differently based on the detected behaviors.

Referring now to FIG. 24, the parking and validation system can eliminate certain MAC addresses by filtering the first six characters of a received MAC address against the database of IEEE device manufacturer assigned MAC prefixes. At 510 a node within a parking client 122A location, such as a node 600 at location 620 described below in FIG. 25, detects a MAC address packet. At 512 the system assesses if the RSSI signal strength exceeds a set threshold. If not, the data is ignored at 520. Next, at 513 the system determines if the MAC address is from a device of an employee, a venue Wi-Fi device, a neighborhood Wi-Fi device, or other device known to the system as not a customer. Again, if it is such a signal, the data is ignored at 520. Next, at 516 if the first six characters of received MAC address do not match prefixes in the IEEE database of MAC prefixes, the MAC address data is ignored at 520. At 518, valid MAC addresses are accepted and can be mapped onto customer identification information stored in the customer database of the parking and validation system 100A.

For each segment of parker, the parking and validation system 100A of the present invention can market services accordingly. For example, monthly parkers for whom the parking facility already has contact information, marketing materials can be sent directly. However, a particular parking facility can see many more MAC addresses than there are contracted monthly parkers. Therefore, the other owners of the devices having other MAC addresses can be targeted for advertising accordingly. For example, if they can be identified as being in a parking facility during weekend events, they can be marketed to accordingly. The system will keep track of all MAC transaction data and associate any and all transaction data from the PARCS system, and will keep this in store age. The marketing can be tailored to the MAC ID's through digital signage, or other means . . . Once a customer ties their ID to the MAC ID then all historical transactional behavior is associated with the customer specific information.

Referring now to FIGS. 25 and 26, a system method for calibrating a system for location determination of computing devices by trilateration is described. The system and method can be practiced in any venue, and is described herein in a non-limiting manner as being practiced in a parking client 122A venue, e.g., a parking facility location 600, and detecting device fingerprints in the form of MAC addresses. For a given parking facility 600 certain nodes 610 can be inside the facility and certain nodes 620 can be outside the facility. In general, by the system and method herein any three nodes detecting a signal from a customer 102 or potential customer, e.g., from a customer's communication device 104 can locate the customer 102. The location information can be tied to the entry/exit locations and can be tied to time stamps of entry and/or exit as a way to tie a customer's computing device (and, therefore, the customer) to a transaction event.

Because every space/venue for various parking facilities can be different, for relatively more exact location calculation in key areas like pay devices, gates, entrances, exits, and the like, it can be beneficial to calibrate each such location. FIG. 26 shows in schematic representation three nodes 600 and the intersection of circles centered on the three nodes. In the present disclosure, the nodes can be centers of spheres, and the intersection of the three spheres can indicate the location of a computing device detected by the three nodes by the process of trilateration. Trilateration is the process of determining absolute or relative locations of points by measurement of distances, using the geometry of circles, spheres or triangles.

In three-dimensional geometry, when it is known that a point lies on the surfaces of three spheres, then the centers of the three spheres along with their radii provide sufficient information to narrow the possible locations down to no more than two (unless the centers lie on a straight line). In the present disclosure, the centers of three spheres can be three nodes in a parking facility, and their respective radii can be determined from signal strength of a computing device, thus determining by known methods a location of the computing device.

However, in practice, location determination can be off due to obstructions, building constraints, and other signal deflectors and blockers that can be present at a parking facility. Thus, proper or sufficient location of a communication device can be hindered by signal readings affected by such signal deflectors and blockers. Thus, it can be beneficial to calibrate any three nodes 600 such that by the method of trilateration more accurate location of computing devices at target areas can be made, whether signals are obstructed or unobstructed. Location of computing devices can be made by detection of a device fingerprint, which as disclosed above, is illustrated in non-limiting embodiments herein by the detection of a MAC address.

In an embodiment, a method of calibrating a system for location trilateration, such as the three nodes 600 in either of FIG. 25 or 26 can be practiced as follows.

In an embodiment, the three nodes 600 can have line of sight (LOS) signal transmission to a target area to be monitored can be installed and their respective GPS locations can be set in the parking and validation system 100A. Nodes can be, for example, Wi-Fi receivers.

A system administrator or other operator selects a first node 600 to calibrate and stands about one-fourth of the distance from the first node and the target area to be monitored and in the software sets the signal strength in dBm for that node and position. A system administrator repeats this process for one-half the distance, three-fourths, the distance, and at the target area, i.e., on the spot, for the first node.

An administrator or operator then repeats the process described above with respect to the first node for each of the other two nodes.

Calibration can then be tested using a computing device broadcasting a MAC address and moving around, e.g., walking around the target area with the computing device. By way of trilateration utilizing the three nodes, the system can locate the computing device being moved around. If the system correctly identifies the MAC address as being sufficiently close to the target area the software configuration is saved.

Once the parking facility calibrates as many nodes as desired, the parking facility can relatively accurately determine the location within or without the parking facility of a given MAC address of a given computing device.

A key piece of information collected by the parking and validation system 100 can be a determination of whether a computing device detected by a MAC address is located inside the parking facility or outside the parking facility. This piece of information can be gathered by utilization of trilateration with any three nodes, and is enhanced by the calibration steps described above, with the additional steps detailed below.

A system administrator with a computing device broadcasting a MAC address can move around, e.g., walk around, an area around the nodes inside a parking facility and can monitor and record a first set of minimum and maximum dBm levels.

A system administrator with a computing device broadcasting a MAC address can then move around, e.g., walk around, an area outside the parking and can monitor and record a second set of minimum (if any) and maximum dBm levels.

The first set of dBm levels can be compared with the second set of dBm levels and a determination at least to a good approximation can be made as to the location of a computing device.

In an embodiment of the system and method of the disclosure the nodes as described above can be beneficially utilized in a parking facility to segment those entering or leaving the parking facility. Such segmentation can be, for example, as discussed above with respect to FIG. 23, contract parkers, passengers, transient parkers, and event parkers. In an embodiment, for example, it can be beneficial to be able with some accuracy to segment parkers and passengers to enable targeted marketing, both inside and outside the parking facility.

Referring to FIG. 27, there is shown a schematic representation of a parking facility 700 having three entry lanes, each having ticket column 652 and a barrier gate 236. It should be appreciated that any of the lanes could be utilized as an exit lane, and the ticket column and barrier gate as described herein can be duplicated on any of the lanes as necessary to enable two-way traffic.

Three nodes 600, which can be Wi-Fi receivers can be placed such that the range of signal reception for each extends to a portion of a lane in which a car 650 entering (or leaving) would stop to receive an entry ticket (or other credential, as disclosed above). This portion of a lane can be considered a target area, i.e., an area in which a parking facility may wish to target identification of computing devices entering or leaving a facility.

In an embodiment, the entry lane and ticket column can have a distance of about 10 to 12 feet (about 4 meters) between the ticket dispenser and the gate 236. Because the distance is limited both due to the width of the entry lane and the length of the ticket dispensing portion of the lane, nodes 600 can be calibrated as discussed above to detect the transmission of signals, such as MAC addresses from any computing devices, such as cell phones, in car 650. The MAC addresses can be stored, and can be matched with time stamps of the ticket column, license plate images, or other criteria collected by a PARCS system. Over time, such MAC addresses can be associated devices of persons who, based on observed and recorded behavior, can be segmented into groups such as customers and potential customers of a parking facility, as disclosed above with reference to FIG. 23. The same methodology can be utilized at foot pay stations, pedestrian walkways and exits, lobby areas,

Segmentation of persons entering or leaving a parking facility can have substantial benefits to both the parking clients, as well as business clients. For example, once the MAC address of a computing device is segmented as belonging to an event parker, real-time digital marketing, e.g., in the form of digital signage, can be presented to the holder of the computing device. For example, a display screen on or near the ticket column 652 can display a marketing advertisement to the event parker, such as special rates on upcoming events. In like manner, digital signage in other parts of the parking facility, including exits, can, in response to the MAC address of a segmented parker, produce targeted advertising, including for parking validation, based on the type of behavior has been observed and recorded for the particular person holding the computing device having the MAC address.

Thus, in an embodiment, the parking and validation system can use a device fingerprint of a computing device, such as a MAC address to geolocate a device. The first place the device can be geolocated can be at an entrance to a parking facility as discussed above, utilizing three Wi-Fi nodes for trilateration.

Another way to geolocate a device, and, therefore, a customer or potential customer is via Global Positioning System (GPS) technology. A GPS connection with a device can occur in several ways in the method and system disclosed herein. For example, if the parking and validation system 100A, such as through the administrative component 112 sends a credential such as a barcode, it can be served up in a HTML page. The HTML page can have JavaScript behind the scene requesting and sending geolocation information for the device back to the servers of the parking and validation system. Geolocation via GPs can also occur when a user accesses his or her account associated with the parking and validation system 100A, including when a user signs into a dedicated Wi-Fi portal. Geolocation data via GPS can also be captured with a user of the parking and validation system 100A opens an email from the system or clicks on a link in a text from the system 100A.

GPS software and hardware of a computing device, for example the computing device 104 of a customer, can be accessed if a device action takes place in a mobile application on the device. In this situation, the parking and validation system 100A can access the operating system's location library and request geolocation information in latitude and longitude. Such access can be pre-approved when the user installs the mobile application.

If a user or customer accesses a web page of the parking and validation system 100A, the system can use the HTML 5 Geolocation API available on all browsers supporting the HTML specification. In an embodiment, the user can be first prompted to permit the parking and validation system 100A to use geolocation, and when approved the system can access geolocation via the API.

In an embodiment, latitude and longitude data obtained from geolocation can be within five or more decimal places of accuracy, which can give accuracy within about 1.1 meters.

In an embodiment, GPS technology can be matched to the MAC address of the devices of users. If a user is in and area of three-node coverage that can perform trilateration, and if the user opens a system web page or mobile application, the parking and validation system 100A can use timestamping to match the geolocation to the device location/MAC from trilateration cross-reference and identify a device of a user who has not registered in the system yet to their devices MAC. An example would a parker who is not a signed up with the system but got a validation credential, e.g., barcode, to use.

In an embodiment, the system can calculate the difference between two sets of longitude and latitude to determine if they are geolocating the same device, e.g., if the two sets of points are within a meter or so of each other. This determination can be made using the Haversine formula using the pseudo code below. This code, as expressed below, can be used, for example, to determine if a trilateration geolocation address is a match with a GPS address within a meter or so.

Haversine formula

a=sin²(Δφ/2)+cos φ1·cos φ2·sin²(Δλ/2)

c=2·atan2(√a,√(1−a))

d=R·c
φ is latitude, λ is longitude, R is earth's radius (mean radius=6.371 km);
note that angles need to be in radians

JavaScript:

varR=6371e3; //metres

varφ1=lat1.toRadians( );

varφ2=lat2.toRadians( );

varΔφ=(lat2−lat1).toRadians( );

varΔλ=(lon2−lon1).toRadians( );

var a=Math.sin(Δφ/2)*Math.sin(Δφ/2)+Math.cos(φ1)*Math.cos(φ2)*Math.sin(Δλ/2)*Math. sin(Δλ/2);

var c=2*Math.atan2(Math.sqrt(a), Math.sqrt(1−a));

var d=R*c;

### Use Cases

The following Use Cases illustrate certain functions and benefits of a system and method for parking validation, and are offered for purposes of understanding, and are not to be limiting in any manner.

### Monthly Parking Validation Use Case

A customer first chooses a level of parking contract by selecting it on a web portal. In this example the customer decided to choose a level that is a platinum level which allows 24-7 access to the facility and also has an unlimited car wash plan from a local merchant. The customer fills out the form on the web portal including personal information and digitally signs the contract. Once accepted by the owner/operator, the parking owner or operator through the middleware will cause a link to download an application to be delivered electronically to the customer. The customer will download the application on their mobile device and a credential will be activated within the application. Location services that use GPS will be enabled. The customer will then use the credential to enter and exit the parking facility, by scanning the credential at the entry and exit device. The application will send notifications or will display offers within the application from local merchants, these notifications and offers will be delivered based on location inside and outside of the parking facility and may be on any route that the monthly parker uses to and from the parking facility. One such type of offer may be to purchase a sandwich meal and earn $3.00 toward your monthly contract amount. When the offer is earned the sandwich shop would credit the account of the contract parker with the specified amount. The middleware would collect the $3.00 from the sandwich shop and deliver it to the parking owner operator for credit against the monthly amount owed by the contract parker. Payment of the remaining balance may either be through the middleware system or may be billed directly by the owner/operator through “normal means”.

### Transient Parker Use Case

A customer first parks at a parking facility and upon entry pulls a ticket from the entry column. Upon walking out of the facility there is digital signage and static signage that encourage signing up for a parking rewards program by signing onto the Wi-Fi network called “Parking-Rewards” to immediately receive a discount on todays parking charge and get a list of other merchants in the area that will pay even more. The customer then signs into the Wi-Fi network through a captive portal and is asked to create an account either by using a social media login or filling out a short form. Once they sign up for the program they are given internet access and a barcode validation for 50% is immediately texted to them. Along with this email there is a list of other merchants that will give other parking validation for todays visit. In this example the customer decided to patronize a restaurant that was on this list for lunch. The offer was to pay 50% of the parking fee if they spend $10.00 or more on lunch. The customer spent $15.00 on lunch and the restaurant handed him a card with a unique code with the message, “Text the code 1234 to telephone number 512-345-6789 to receive your validation.” The customer follows this instruction and the system sends to the customer a revised barcode that sums the total amount of validation available, which in this example is 100% of the parking fee. 50% was earned from the parking facility venue directly for signing up to the program, 50% was earned from the restaurant. Upon exit from the facility, the customer inserts the ticket that was originally pulled into the exit station and the exit station shows the total amount owed,. The customer then scans the latest barcode that was delivered to their phone, at which point the fee is eliminated and the customer is allowed to leave the facility for no charge.

### Validation Delivery Use Case

A customer first parks at a parking facility and upon entry pulls a ticket from the entry column. The customer then goes to the attorney's office and hands the ticket that he pulled to the person at the front desk (the validator). The validator logs on to a portal with a username and password. The interface then allows for entry of the ticket information. The system then looks to see if the ticket information provided is an open ticket in any of the systems that its is connected to. If the ticket is open, the validation can be applied electronically to the ticket through integration with the PARCS system. The validator asks the customer for an email, or a phone number so that they may send them the validated ticket. The system reproduces the barcode ticket and sends that barcode ticket to the customer. The validator would then keep the ticket that was handed to them. The customer would then present the barcode ticket at the PARCS system. If it is fully validated the patron would be allowed to leave with no additional payment. IF the ticket is only partially validated then the remaining balance due would be paid through normal means in the PARCS system.

In describing the embodiments of the invention, specific terminology will be resorted to for the sake of clarity. However, the invention is not intended to be limited to the specific terms so selected, and it is to be understood that each specific term includes all technical equivalents that operate in a similar manner to accomplish a similar purpose.

What is claimed is:

1. A system for segmenting computing devices entering a parking facility, the system comprising:
at least three nodes, the at least three nodes having locations known via GPS technology and capable of receiving at least one device fingerprint from a broadcast signal from at least one computing device in a target area, the at least three nodes calibrated to determine a geolocation of the at least one computing device through trilateration;
a parking entry station comprising an entry credential dispenser situated such that upon entry to the parking facility, a user in possession of one of the at least one computing device is in the target area and receives an entry credential at the parking entry station; and
a processor and memory having executable instructions for associating the at least one device fingerprint with information relating to the entry credential.

2. The system of claim 1, wherein the broadcast signal is selected from the group consisting of RFID, UHF, NFC, Bluetooth, sound waves, and Wi-Fi.

3. The system of claim 1, wherein the at least one device fingerprint is a MAC address.

4. The system of claim 1, wherein the entry credential dispenser comprises a ticket dispenser and the entry credential is a ticket dispensed from the ticket dispenser and the information relating to the entry credential includes information selected from the group consisting of time of credential dispensing and license plate information.

5. The system of claim 1, wherein the at least three nodes are calibrated to locate within one meter the geolocation of the at least one computing device.

6. The system of claim 1, wherein two or more device fingerprints are detected in the target area.

7. A parking system for use by one or more parking clients, one or more business clients, and a customer, the parking system comprising:
one or more parking clients each having a parking client location and a parking client communication device;
a customer each having a customer input/output device;
an administrative component having a computer system including a processor and memory comprising executable instructions;
wherein each of the parking client location has at least three nodes having locations known via GPS technology and capable of receiving a device fingerprint from a broadcast signal from the customer input/output device in a target area, the at least three nodes calibrated to determine a geolocation of the customer input/output device through trilateration, and wherein the device fingerprint is recorded in the parking client communication device;
wherein the parking client communication device operates to transmit to the administrative component the device fingerprint of the customer input/output device and wherein the administrative component operates to use the device fingerprint in combination with customer information to segment the customer by behavior into a customer behavior type; and
wherein the administrative component further operates to transmit at least one incentive to the customer based on the customer behavior type.

8. The parking system of claim 7, wherein the broadcast signal is selected from the group consisting of RFID, UHF, NFC, Bluetooth, sound waves, and Wi-Fi.

9. The parking system of claim 7, wherein the device fingerprint is a MAC address.

10. The parking system of claim 7, wherein the customer information includes information selected from the list consisting of a parking client location being used by the customer, a time and date when the customer entered the parking client location, a frequency that the customer uses the parking client location, a purpose that the customer is at the parking client location, demographics information, and customer preferences.

11. The parking system of claim 7, wherein the administrative component further operates to identify one or more second client locations located along a selected path of travel of a customer traveling from a first client location.

12. The parking system of claim 7, wherein the administrative component further operates to identify one or more second client locations that relate to customer preferences of the customer.

13. The parking system of claim 7, wherein at least one incentive is directed to the customer and operates to provide an incentive to the customer to enter a first client location or a second client location.

14. The parking system of claim 7, wherein at least one incentive is directed to provide an incentive to the customer to enter a second client location.

15. The parking system of claim 7, wherein the administrative component collects the customer information and transmits the customer information to the one or more parking clients.

16. The parking system of claim 7, wherein the administrative component identifies various events scheduled to be held within a defined area during a selected period of time and identifies all customer locations within the defined area and transmits an incentive to a customer input/output device for all customers having a customer preference that relates to the various events.

17. A system for use by one or more parking clients and one or more customers, the system comprising:
one or more customers each having a customer input/output device, wherein the customer input/output device operates to transmit a MAC address over a wireless emitted signal;
one or more parking clients each having a parking client location and a parking client communication device, wherein each the parking client location has at least three nodes having locations known via GPS technology and capable of receiving a MAC address from the wireless emitted signal from the customer input/output device in a target area, the at least three nodes calibrated to determine a geolocation of the customer input/output device through trilateration, and wherein a device fingerprint is recorded in the parking client communication device, wherein the parking client communication device can receive the MAC address and other customer information;
a portal that operates to allow the one or more customers to register with the system and enter customer information;
an administrative component comprising a computer system having a processor for operating administrative system software and wherein the administrative component operates to be in communication with the customer input/output device and the parking client communication device;
wherein when the at least three nodes are operably configured to receive an emitted signal and the MAC address from the customer input/output device, and the parking client communication device is operably configured to transmit the MAC Address to the administrative component;
wherein the administrative component using type information and the MAC Address to identify the one or more customers operates to segment the one or more customers into a customer type; and
wherein the administrative component further operates to use the customer information and the customer type to send an incentive to the one or more customers.

18. The system of claim 17, wherein the customer information is transmitted on a signal selected from the group consisting of RFID, UHF, NFC, Bluetooth, sound waves, and Wi-Fi.

19. The system of claim 17 wherein the administrative component further operates to monitor and determine a redemption rate for each of the incentive for each customer type and calculates an effectiveness quotient and if the effectiveness quotient falls below a threshold amount, the incentive for the customer type is modified.

20. The system of claim 17 wherein the administrative component further operates to identify one or more second client locations located along a selected path of travel of a customer traveling from a first client location.
